(19) United States
(12) Patent Application Publication
(10) Pub. No.: US 2009/0241450 A1
(43) Pub. Date: Oct. 1, 2009

(54) COMPOSITION OF A WEATHERABLE ROOFING COMPOSITE PRODUCT

(76) Inventors: Frank Lane Italiane, Santa Ana, CA (US); Amit Kurupathi, Santa Ana, CA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/129,587

(22) Filed: May 29, 2008

Related U.S. Application Data
(63) Continuation of application No. PCT/US05/43443, filed on Nov. 30, 2005.

(51) Int. Cl. E04C 2/20; B32B 37/02

(52) U.S. Cl. 52/309.3; 52/309.1; 52/309.4; 52/311.1; 52/406.2; 52/309.13; 156/182; 156/60; 156/306.6; 156/280; 977/773

(57) ABSTRACT

A novel composition of weatherable and semi-weatherable materials that can be injection molded or extruded into sheets or rolls to create a roofing product wherein the roofing product overlaps in order to provide a substantially weatherable covering on a roof. The roofing product has a top layer (14) made of weatherable polymers and multiple substrate layers (22, 30) made of semi-weatherable polymers. A decorative, three dimensional appearing layer (16) of colorants is uniquely applied to the bottom surface (15) of the top layer (14). The weatherable top layer (14) is preferably an ASA or acrylic-type copolymer. The semi-weatherable bottom layers (22, 30) are specialized formulations of fire resistant polymers, where the semi-weatherable bottom layers (22, 30) have had the Heat Deflection Temperature (HDT) uniquely improved for use in roofing. The product has multi-layering UV stability. The multiple layers can be injection molded or extruded or laminated or preferably multi-layer-extruded, thus bonded. Then the bonded materials maybe used directly as a finished roofing product (10) or thermoformed product (10a) (if not injection molded) to resemble more popular types of roof coverings such as shake or shingles or slate or tiles or geometric and natural patterns. The multiple layers are engineered to pass stringent roofing building codes such as the International Construction Code (ICC), including fire rating

### CROSS REFERENCE TO RELATED APPLICATIONS

This Application is a continuation of and claims priority from PCT Application Serial No. PCT/US05/43443, filed Nov. 30, 2005.

### BACKGROUND OF THE INVENTION

(1) Field of the Invention

This invention pertains to roofing materials. More specifically, the invention concerns a novel composition of materials to create lightweight, decorative, weatherable multi-layer polymeric roofing system to meet specific building code requirements set by the International Code Council (ICC).

(2) Description of the Related Art

This specific roofing product patent application is a continuing improvement of the inventor's previous patent U.S. Pat. No. 6,536,177. A patent search before and after issuance of the inventor's previous patent U.S. Pat. No. 6,536,177 does not indicate any of the present invention's improvements. Further U.S. Pat. No. 6,536,177 was shown to be differentiated from the closest prior art of U.S. Pat. No. 5,306,548 issued to Zabrocki, et al. entitled “Coextruded weatherable film structures and laminates” and U.S. Pat. No. 5,334,450 issued to Zabrocki, et al. entitled “Weatherable styrenic film structures with intermediate tie layer and laminates thereof.

Many types of roofing materials are available, and some of the more popular types include shake, shingles, slate and tiles. Tiles are quite durable; however, their disadvantage is that they require a substantial amount of labor in their installation and can break on impact. Tiles tend to be excessively heavy and dangerous in earthquakes and high winds, and will fall through the roof in the event of a fire. Tiles are also expensive to ship because they are so heavy. Wood shakes and shingles are also subject to breakage as well as rot and loss of coloration. Their cost is high and they are labor intensive to install. Furthermore, wood shakes and shingles can be relatively heavy, are flammable, porous and cannot withstand relatively high wind velocity.

The inherent disadvantages of tiles and shakes have led to the development of alternative roofing materials such as plastics. Several different types of plastics are known in the art. However, many of the plastics have disadvantages, which typically may include poor ability to insulate, poor ability to withstand the ultra violet (UV) radiation from the sun, and poor ability to withstand shock from an impact (such as from people walking on the roof or hail). Plastics tend to become brittle, deformed and break with age. Also, plastics tend to loose color over time.

Because of these disadvantages, the majority of roofing materials are made of asphalt shingles. Asphalt shingles excel over most natural looking roofing materials. However, the natural materials are still in high demand because the asphalt shingles are unattractive and simply utilitarian in appearance.

Prior art teaches layers that are internally adhered by an adhesive. This bonding method is not applicable for a roofing application because of the extreme weathering conditions and subsequent failure by delaminating of layers or adhesive chemical incompatibilities with materials including colorants. The present invention has overcome these issues in a roofing material. Prior art teaches protective coatings on polymers that can include clear coats to resist staining from airborne dirt and pollutants. For example, Samafil, Inc., Canton, Mass. for their Saranfil thermoplastic roofing membrane applies a sprayed lacquer coating to the top of the membrane for this purpose.

Prior art teaches printing on polymers that can include clear coats to protect the printing colorant from UV and weathering. For example, IB Roofing Systems of Eugene, Oreg. and Cooley Building

Products of Pawtucket, R.I. print a composite shingle pattern on top of the PVC membrane and then apply a sprayed clear acrylic or acrylic/PVC coating to protect the printing. The clear coat that protects the printing has a warranty of less than five years. Generally roofing materials must have at least a ten year life. This method will not hold up to the extreme weathering of a roof, where the protective coating peels, discolors, wears from blowing dirt and, most importantly, deteriorates the printed materials. The present invention has overcome these problems and has increased the useful life of the substrate layers to over 30 years by molecularly bonding the materials and other means that are described herein.

Several prior art patents in the field of alternative roofing system include U.S. Pat. No. 5,525,413 issued to Daurer, et. al. entitled “Industrial roofing fabric”, U.S. Pat. No. 4,507,347 issued to Lupton, et. al. entitled “Laminate” and U.S. Pat. No. 4,307,552 issued to Votte entitled “Synthetic roofing elements of the slate type and method of manufacturing same”, U.S. Pat. No. 5,306,548 issued to Zabrocki, et al. entitled “Coextruded weatherable film structures and laminates” and U.S. Pat. No. 5,334,450 issued to Zabrocki, et al. entitled “Weatherable styrenic film structures with intermediate tie layer and laminates thereof.

However, none of the prior art teaches material having the features and structural composition as in the present invention.

The composition of the roofing material is highly important in order to maximize protection from the natural elements and chemical pollution. Chemical pollution results from chemicals contained in smog and other air pollutants. These chemicals contribute to color loss, brittleness and other factors that decrease the durability of many types of roofing materials.

Thus, it is a primary objective of the present invention to provide a composition of a roofing material that provides ultraviolet protection, flame and fire retardancy, insulation, weatherability, longevity, durability and a new level of beauty in roofing materials. Another objective of the present invention is to provide a composition of a roofing material that is lightweight and provides maximum protection from the weather and chemical pollution. Most importantly, the invention passes stringent building codes specific to roofing test requirements, where the majority of polymeric roofing materials have failed overtime.

It is important to note that the prior art is not specific to a plastic roofing product such as the present invention. Furthermore the prior art is silent as to the ability of their compositions' ability to pass stringent building codes. Therefore, it is important to define the term “plastic roofing product” as defined by ICC AC07 & AC75.

The ICC AC07 & AC75 documents are universal construction standards issued by the

International Conference of Building Officials (ICBO), under the International Building Code (IBC). On Feb. 1, 2003, ICC Evaluation Service formally joined with the National Evaluation Service, BOCAI evaluation services and SBCCI PST & ESI in the new ICC Evaluation Service, Inc. (ICC-ES). ICC-ES is a subsidiary of the International Code Council. 5203 Leesburg Pike, Suite 600; Falls Church, Va. 22041.

ICC AC07 & AC75 (Plastic Roofing Products) define performance standards for finished products as opposed to siding or other construction material that are required to meet a process standard. ICC AC07 & AC75 defines plastic roofing products as a “fire classified, finished product with specific performance standards”. On the other hand, ICC AC37, which applies to siding, only defines a “process standard”. A process standard is very specific as to what types of materials and manufacturing process can be used. A performance standard is based solely on the performance of a finished product: not on the type of materials or manufacturing processes that may be used. In order to conform to ICC AC07 & AC75, a plastic roofing product must meet specified Acceptance Criteria (AC) and independent testing requirements.

The Zabrocki et al. U.S. patents (U.S. Pat. Nos. 5,306,548 or 5,334,450) do not define a plastic roofing product requirements or in any way indicate that these inventions meet roofing building code requirements. For example U.S. Pat. No. 5,334,450 states only that their invention can be used as a weatherable film for lamination to a non-weatherable substrate, such as wood, metal or plastic. See claim 1 and column 9 line 1. There is no reference to ICC AC07 & AC75. The Zabrocki et al. U.S. patents (U.S. Pat. Nos. 5,306,548 or 5,334,450) are not germane to a plastic roofing product and meeting ICC AC07 & AC75 requirements. Zabrocki's formulations (U.S. Pat. Nos. 5,306,548 or 5,334,450) do not meet plastic roofing building code requirements.

There are a limited number of materials that provide a clear weatherable film such as polycarbonate, polymethyl methacrylate (PMMA) and acrylic plastic. The drawback for the use of such materials for roofing is decorative coloration, cost and durability. The present invention has overcome these issues as described below.

Coloration of plastics is a common practice to provide visual enhancement. However, in a weatherable roofing application decorative designs by coloration to resemble the intricate features of roofing materials such as shake, slate or tile have never been seen before. Also, coloration has been unsuccessful in meeting the long term performance of roofing or the weatherable demands placed on the materials such as chemical compatibility, UV protection of the colorants and materials used. Further, realistic coloration to resemble marble or wood grain in roofing is non-existent until the present invention.

Another problem with most coloration processes is that it is applied to the exterior of a surface to gain control over the design. This method is impractical in a roofing application because chemicals, pollutants, wind, sand and other forms of weather will wear the colorants off the surface in a short time. Still another problem is that if one is to encapsulate a decorative faux design between two solid layers, then the design would be covered from view by the top layer. The only way the design could be seen is if a clear or nearly clear top layer is used. Using a clear material invites UV degradation which would be fatal for a full sun roofing material. Creating decorative faux designs such as wood grain, marble or other natural designs has never been done in a roofing application to meet building code requirements until this present invention. Further, colorants are mostly very flammable and not applicable for a fire rated roofing application. For the first time, the present invention has created decorative or faux (three dimensional) designs to resemble such roofing materials as shake, slate and tile and other designs such as leaves and sea shells or geometric patterns, in a weatherable manner that is able to achieve the required roofing building code performance requirements, including fire retardancy.

Prior art teaches layers that are adhered by an adhesive, not to be confused with the use of adhesives for bonding the present invention to the undersurface of a roof. This interlayer adhesive bonding method is not applicable for a roofing application because of the extreme weathering conditions and subsequent failure by delaminating of layers or adhesive chemical incompatibilities with materials including colorants.

### SUMMARY OF THE INVENTION

The present invention is a novel composition of weatherable (over 25 years) and semi-weatherable (less than 25 years) materials that can be injection molded, extruded or laminated into sheets or rolls to create a roofing system wherein the rolls or sheets are overlapped in order to provide a substantially weatherable covering on a roof. The roll or sheet member has a top layer made of weatherable polymers and substrate layers made of semi-weatherable polymers. Decorative coloration is • applied to the layers and acts as a layer in itself. The weatherable top layer materials include:

acrylic plastic;

polymethyl methacrylate (PMMA);

acrylonitrile/styrene/acrylate polymer (ASA);

polycarbonate (PC);

polyvinylchloride (PVC); or

a copolymer of any mixtures of the said weatherable top layer materials;

to create a superior structure for use in roofing applications as described herein.

The present invention defines “acrylic plastic” as base polymers that include polymers of acrylic acid and/or polymers of monomers structurally derived from acrylic acid or are copolymers of acrylic acid or its derivatives with other monomers. An example of a popular plastic in this family is polymethyl methacrylate (PMMA), which term can be used interchangeably with acrylic plastic herein. The acrylic plastic can be formulated with butyl and ethyl acrylates. This weatherable top layer polymer has high resistance to weathering because the molecular structure comprises a high concentration of stable, polymeric UV screener. Acrylic plastic has a significantly higher resistance to UV radiation and attack by atmospheric oxygen than the butadiene rubber which is used, for example, in impact-modified polystyrene and acrylonitrile/butadiene/styrene (ABS). The present invention defines

Acrylonitrile/Styrene/Acrylate polymer (ASA) as being specially formulated to have high tensile strength, elongation at break, modulus of elasticity in tension, impact strength, Vicat softening temperature and density. It is an impact modified, weatherable, copolymer with high thermal stability, good chemical resistance, and resistance to weathering, aging, and yellowing.

The semi-weatherable substrate materials layers are made from formulations of:

a specialized formulation of acrylic;

a specialized formulation of high impact polystyrene (HIP);

a specialized formulation of polyethylene terephthalate (PET) modified with cyclohexanedimethanol (CHDM);

a specialized formulation of polycarbonate (PC);

a specialized formulation of acrylonitrile/styrene/acrylate polymer (ASA);

a specialized formulation of polyvinylchloride (PVC);

a specialized formulation of copolymer alloy (CPA);

a specialized formulation of thermoplastic olefin copolymers (TPO);

a specialized formulation of acrylonitrile butadiene styrene (ABS);

a specialized formulation of ethylene propylene diene terpolymer (EPDM);

a specialized formulation of thermoplastic elastomers (TPE);

a specialized formulation of polyethylene (PE);

a specialized formulation of polypropylene (PP);

a specialized formulation of fire retardant/fire resistant foams that may include polyurethane foam, polyurea foam, polystyrene foam, polyethylene foam or PVC foam; or

a specialized formulation of copolymers and/or mixtures of the said semi-weatherable materials;

herein referred to as “substrate layers”.

Ingredients such as Titanium Dioxide (TiO₂), Antimony Oxide (Sb₂O₃), Magnesium (Mg), Calcium

Carbonate (CaCO₃), Zinc (Zn), Tin Oxide (SnO) and several other metal/metal-oxide powders as well as non-metal/non-metal-oxides and other metal/non-metal compounds can be incorporated during the compounding process and/or during the extrusion process. These ingredients can incorporated as nanoparticles (1-100 nm), micron size particles or mixtures of nanoparticles and micron size particles.

The Heat Deflection Temperature (HDT) has been uniquely improved for use in roofing by these special and unique formulations and process for the semi-weatherable substrate layers.

The layers are injection molded, extruded, or laminated, but preferably multi-layer-extruded, and thus bonded. Then, the bonded materials may be used directly as a finished plastic roofing product or thermoformed or injection molded, to resemble more popular types of roof coverings such as shake or shingles, slate or tiles. The exception of a semi-weatherable layer being applied by injection molding, extrusion, or lamination and thus bonded is where the fire-retardant/fire-resistant foams such as polyurethane foam, polyurea foam, polystyrene foam, polyethylene foam or the PVC foam are applied by filling, pouring, spraying or injecting after the injection molding, extrusion or thermoforming process. The layers are engineered to pass stringent roofing building codes such as the International Construction Code (ICC), including fire rating.

The present invention (plastic roofing product) is a specialized polymeric formulated fire classified product unlike other construction material. The present invention meets the requirement of ICC AC07 & AC75. Other polymers, available in the marketplace will not meet the requirements of ICC AC07 & AC75.

The present invention was formulated and tested to specifically meet ICC AC07 & AC75 requirements. In doing so, the present invention (plastic roofing product) is useful only for its intended purpose, as a plastic roofing product and cannot be interchangeable with other material not intended as a plastic roofing product under the ICC AC07 & AC75 definition. The present invention is a finished plastic roofing product, not a material for a variety of uses.

The present invention meets the need for a durable multi-layer polymeric roofing system with extended warranty. The invention is not a film, but a finished product which is shaped to look like wood shake, shingles, tile, etc. or a flat roofing sheet with artistic designs that simulate three dimensional finished roofing products like wood shake, slate, clay tiles, etc.

The present invention teaches numerous ingredients formulated into a weatherable top layer and semi-weatherable substrate layers molecularly bonded with one another to meet ICC requirements. The present invention has been designed to molecularly bond its layers without the need for an adhesive layer for bonding which would be impractical in the extreme environment that a roofing material experiences. The present invention is improved over Zabrocki et al (U.S. Pat. Nos. 5,306,548 or 5,334,450) without the need for adhesive interlaminate layers for bonding.

The present invention uses specialized proprietary formulated weatherable and non-weatherable polymers that are needed to meet roofing material performance building code tests such as Weatherometer, pre- and post-aging flexural and tension tests, impact, and fire resistance. Most colorants are introduced into the base material then injection molded or extruded. The present invention created a process using colorant particles that have been engineered to maintain their physical integrity creating a “streaking effect” during polymer flow that looks like the natural striations in marble or wood grain. These colorant particles flow with the other materials while traveling through the barrel across the screw inside the extruder.

The present invention created a new and innovative process of coloration to resemble three dimensional natural designs such as wood grain, leaves, marble or geometric patterns for a roofing application for the first time that can be applied by specialized inkjet, flexographic or rotogravure printing. The preferred printing method is by inkjet in specific artistic applications. To be applicable for roofing durability, design and ICC requirements, new methods were required. The colorants used are compatible with the top and substrate layer materials. Many tests resulted in failure because the colorants contaminated the top layer or substrate layer causing, tearing, delaminating, degradation, brittleness, and discoloration. Printing colorants or inks are not normally compatible with the materials used in the invention. Specific colorants had to be developed to be compatible with the materials used and then be able to attach/bond to the materials to prevent smearing and to withstand weatherable roofing requirements. Another aspect to overcome was the colorants to have good UV & IR resistance, good adhering properties to other materials and flame retardance. Furthermore, a method was devised so the colorants are protected from weathering by the encapsulation of the colorants between the top and substrate layer without affecting the decorative design in the lamination or extrusion process. Thus, decorative three dimensional and faux designs are processed on the underside of the top layer material to be bonded to the substrate layers, so as to not expose the colorants to the weather but still be able to see the encapsulated decorative and faux designs through the clear or transparent top layer.

The present invention must be fire tested and rated for its ability to retard ignition and flame spread. The fire rated system of the present invention and the testing agency must be approved by building code officials.

Recently, photovoltaic (solar) panels have been integrated to look like traditional roofing materials such as tiles and shingles by such companies as BIPV, General Electric, PowerLight and Sharp. The present invention has gone beyond integrating the look of the solar panels with roofing tiles and shingles. The present invention incorporated photovoltaic generating film amorphous devices encapsulated under the top layer for weatherable and natural designs, such as tile and shake. Therefore, the present invention has utilized its unique coloration designs, UV stability, fire retardant, layer composite and building code approval materials to incorporate a photovoltaic generating system that has he natural look of roofing materials. Where a photovoltaic module may serve as a shingle, tile or other building material such as in Bressler et al U.S. Pat. No. 5,590,495 or Younan et al U.S. Pat. No. 5,437,735, the present invention is an actual polymeric shingle, tile or other roofing material with photovoltaic generating technology incorporated within the layers of the present invention with its advantages and innovations. There is no difference in the appearance of the roofing materials as with all other solar, photovoltaic roofing systems. When the present invention is used as a photovoltaic panel, electrical connectors are used for connections between each of the present invention's (plastic roofing products) panels. As stated herein, a “tie layer” may be used to tie the photovoltaic generating device to the composite of layers.

An appreciation of the other aims and objectives of the present invention and a more complete and comprehensive understanding of it may be achieved by referring to the accompanying drawings and studying the following description of the best mode for carrying out the invention.

### BRIEF DESCRIPTION OF THE DRAWINGS

FIG. 1 is a sketch showing an exploded view of the various layers of the non-thermoformed preferred embodiment of this invention. This product has an approximate 50 year life.

FIG. 2 is a sketch illustrating, in exaggerated cross-section, the thermoformed preferred embodiment after thermoforming.

FIG. 3 is a sketch showing an exploded view of the various layers of the non-thermoformed alternate embodiment of this invention. This embodiment has an approximate 25 year life.

FIG. 3A is a sketch showing an exploded view of the various layers of the non-thermoformed second alternate embodiment of this invention.

FIG. 4 is a sketch illustrating, in exaggerated cross-section, the thermoformed alternate embodiment and second alternate embodiment after thermoforming.

FIG. 5 is a sketch illustrating, in exaggerated cross-section, the special alternate embodiment in which one layer of foam is shaped to produce a raised center portion for the thermoformed embodiments.

FIG. 6 is a sketch illustrating the view from the bottom of an actual thermoformed embodiment, alternate embodiment or second alternate embodiment of this invention.

FIG. 7 is a cross section along the lines 7-7 of FIG. 6.

### DETAILED DESCRIPTION OF THE PREFERRED EMBODIMENT

The present invention (plastic roofing product) comprises a sheet or roll member having a top layer and substrate layers.

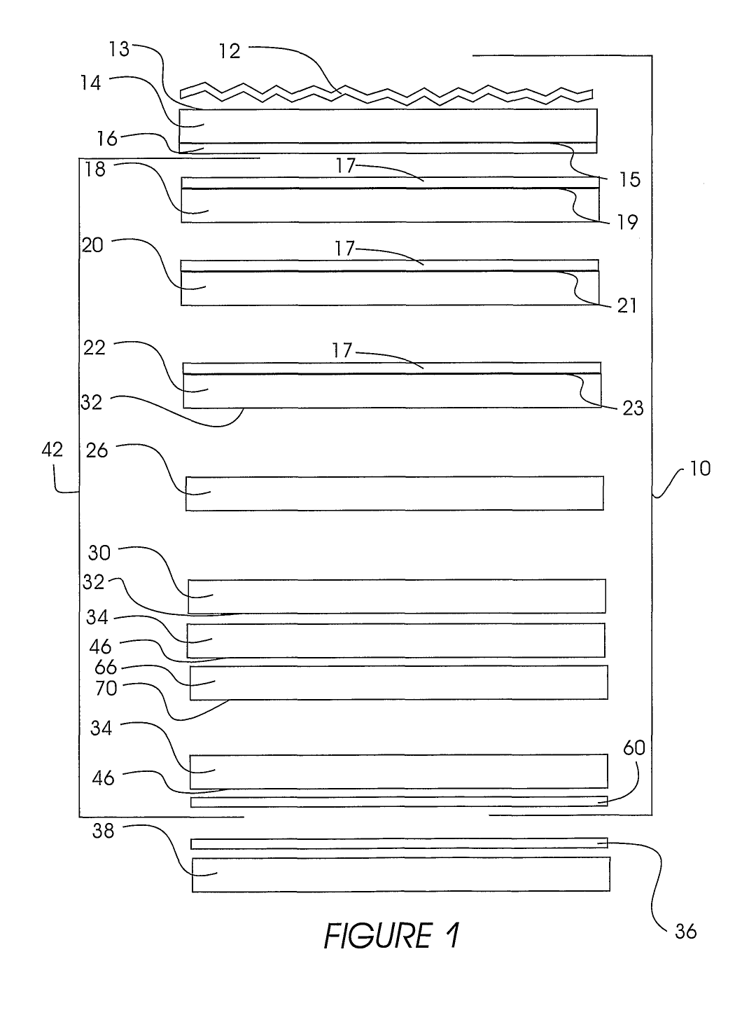

FIG. 1 illustrates the sheet or roll preferred embodiment 10 of this invention. This embodiment

10 comprises:

a UV stabilized top layer 14 made of weatherable top layer materials; and

a substrate layer 22 which is made of semi-weatherable materials and formulated with fire retardants and UV stable colorants. The invention 10 may also include a tie layer 20 to tie the top layer 14 and substrate layer 22 together.

The invention 10 may also include:

a scrim layer 26; and

a second substrate layer 30 which is made of the same formulated semi-weatherable material.

The invention 10 may also include an intumescent fire retardant/fire-resistant layer 34 applied to the bottom 32 of the substrate layer 22 or 30.

The invention 10 may also include a fire-retardant/fire-resistant foam layer 66 applied before or after the intumescent fire retardant layer 34 to the bottom 32 of the substrate layer 22 or 30.

The invention 10 may also include a layer of photovoltaic film cells 18 between the top 14 and the substrate 22 or tie layer 20.

The invention 10 may also include a layer of skid- & UV resistant-material 12 applied to the top

13 of the top layer 14. This layer may, in addition, be UV resistant.

The invention 10 may also include a layer 16 of UV stable colorants, applied to the underside 15 of the top layer 14. In this case the top layer 14 must be clear.

The invention 10 may also include a layer 60 of fire retardant/fire resistant cloth, felt, paper or polymer.

The invention 10 may also include a second layer 17 of UV stable colorants, applied to the top side 19 of the layer of photovoltaics 18, the top side 21 of the tie layer 20, or the top side 23 of the substrate layer 22. The layer 16 or layers 16, 17 of colorants thus become encapsulated between layers

14 and 18, 20 or 22 of the invention 10. The colorants 16 and 17 may be applied under heat and the composite 10 may be annealed after encapsulating the colorants 16, 17. The layer 16 or layers 16, 17 of colorants can be applied in a pattern that simulates a three dimensional natural roofing product or a natural product (such as marble or sea shells) or any fanciful design, when viewed from a distance.

In another alternative the top layer 14 may include colorant particles disbursed in the semi-weatherable plastic. The properties of these colorant particles are engineered to release color in a predetermined manner. In other words, the size, hardness, melt rate and Vicat softening point, etc. are controlled so that they spread out at processing speeds and temperatures to create design patterns such as wood grain and marble appearance. These colorant particles are also slightly miscible with the top layer 14 materials so that they also color the entire top layer.

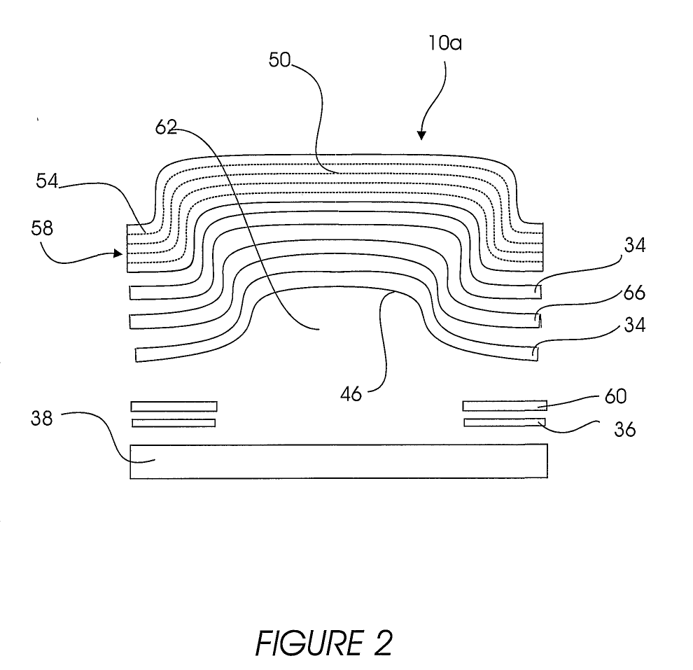

The layers indicated on FIG. 1 by the bracket 42 are called the base. FIG. 2 illustrates the thermoformed preferred embodiment 10a of this invention 10. This embodiment 10a comprises all the layers described above for the sheet or roll embodiment 10. However, the layer of intumescent fire retardant 34, fire-retardant/fire-resistant foam layer 66 and fire retardant/fire resistant paper must be applied after thermoforming.

The invention 10, 10a is fastened over the underlayment 38 of a roof. Methods of attachment include a layer of adhesive. This includes double sided adhesive tape and a bead of adhesive.

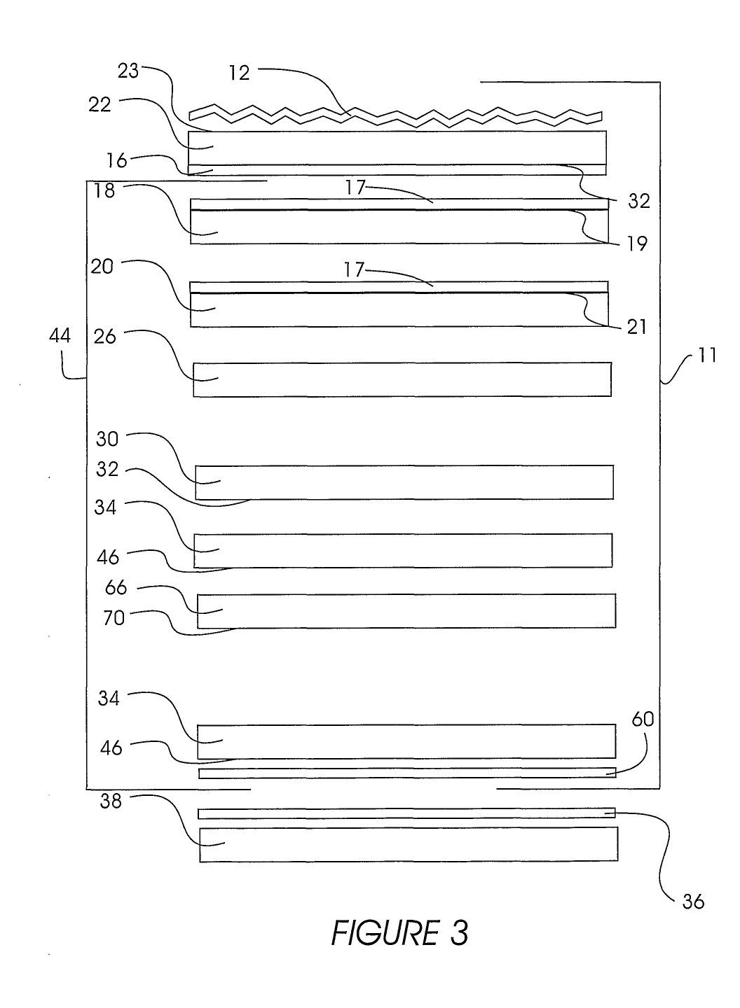

FIG. 3 illustrates the sheet or roll alternate embodiment 11 of this invention. This embodiment 11 comprises:

a substrate layer 22 which is made of semi-weatherable materials and formulated with fire retardants and UV stable colorants.

The invention 11 may also include:

a scrim layer 26; and

a second substrate layer 30 which is made of the same formulated semi-weatherable material.

The invention 11 may also include a tie layer 20 to tie the substrate layer 22 and scrim layer 26 together.

The invention 11 may also include an intumescent fire retardant layer 34 applied to the bottom 32 of the substrate layer 22 or 30.

The invention 11 may also include a fire-retardant/fire-resistant foam layer 66 applied before or after the intumescent fire retardant layer 34 to the bottom 32 of the substrate layer 22 or 30.

The invention 11 may also include a layer of photovoltaic film cells 18 between the substrate 22 and tie layer 20 or second substrate layer 30.

The invention 11 may also include a layer 60 of fire retardant/fire resistant cloth, felt, paper or polymer.

The invention 11 may also include a layer of skid resistant material 12 applied to the top 23 of the substrate layer 22. This layer may, in addition, be UV resistant.

The invention 11 may also include a layer 16 of UV stable colorants, applied to the underside 32 of the substrate layer 22. In this case the substrate layer 22 must be clear.

The invention 11 may also include a second layer 17 of UV stable colorants, applied to the top side 19 of the layer of photovoltaics 18, or the top side 21 of the tie layer 20. The layer 16 or layers 16, 17 of colorants thus become encapsulated between layers 22 and 18, or 20 of the invention 11. The colorants 16 and 17 may be applied under heat and the composite 11 may be annealed after encapsulating the colorants 16, 17. The layer 16 or layers 16, 17 of colorants can be applied in a pattern that simulates a three dimensionπε natural roofing product or a natural product (such as marble or sea shells) or any fanciful design, when viewed from a distance.

In another alternative the substrate layer 22 may include colorant particles disbursed in the semi-weatherable plastic. The properties of these colorant particles are engineered to release color from in a predetermined manner. In other words, the size, hardness, melt rate and Vicat softening point, etc. are controlled so that they spread out at processing temperatures to create design patterns such as wood grain and marble appearance.

The layers indicated on FIG. 3 by the bracket 44 are called the base.

FIG. 3A illustrates the sheet or roll second alternate embodiment 25 of this invention. This second alternate embodiment 25 is identical to the alternate embodiment 11, previously described, except that it lacks the substrate layer 22 and the first or only layer of colorant 16. In addition the layers of colorant 17 can go on top 19 of the layer of photovoltaics 18, on the bottom 31 of the layer of photovoltaics 18 or on top 21 of the tie layer 20. If the colorant 17 is below the layer of photovoltaics 18, the layer of photovoltaics 18 is clear.

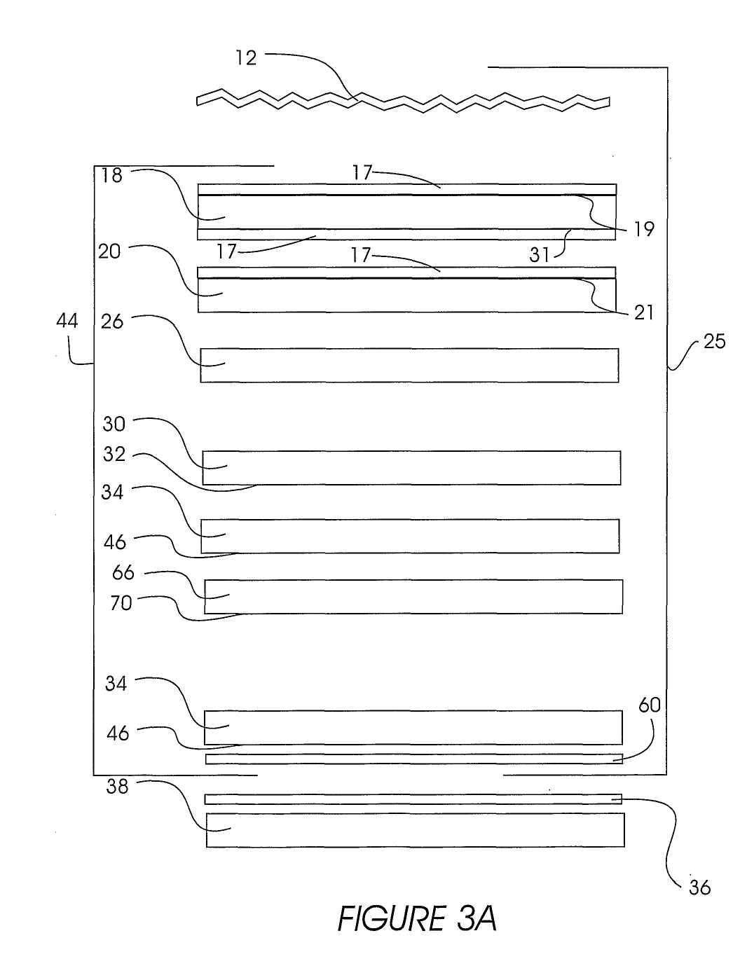

FIG. 4 illustrates the thermoformed alternates 11a, 25a of this invention 11, 25. These embodiment 11 a, 25a comprises all the layers described above for the sheet or roll embodiment 11, 25. However, the layer of intumescent fire retardant 34, fire-retardant/fire-resistant foam layer 66, and fire retardant/fire resistant paper 60 must be applied after thermoforming. These embodiments are formed to have a raised central portion 50 and at least one flat lip 54.

The invention 11, 11a, 25, 25a is. fastened over the underlayment 38 of a roof. One method of attachment is by adhesive 36, including double sided adhesive tape.

The top layer 14 is made of weatherable materials to create a molecularly superior structure for use in certain applications which are described herein. The substrate layers 22, 30 are made of specially formulated semi-weatherable components as described, for use as a roofing product. The layers of the invention as defined in FIG. 1 and 2 can be laminated by extrusion, multi-layer-extrusion, laminating or injection molding. For a dimensional look of shake, slate, shingle or tile the laminate may be thermoformed or molded. Also, the material may be decoratively colored to resemble shake, slate, marble, shingle or tile for example.

The top layer 14 can also be colored with a colorant so that it has a solid color. Alternatively, colorant particles can be incorporated into this layer 14 during processing so that the particles melt and spread out during processing to create random patterns of marbleized or wood grain effects.

The colorant 16, 17 used in this invention 10, 10a is preferably specially formulated acrylic so as to be molecularly compatible with the layers 14 and 18, 20 or 22 between which it is encapsulated. Alternatively it can be designed to etch into and bond with the layers 14 and 18, 20 or 22. The sheet or roll member has a top surface 13 exposed to the elements, intermediate substrate layers 22, 30 and a bottom surface 46 that faces the sub surface 38 of the roof when the plastic roofing product 10 is placed on the roof.

The substrate layers 22, 30 are made of proprietary formulations of semi-weatherable compounds for use in roofing materials. The present invention uses a proprietary specialized weatherable top layer 14 and semi-weatherable substrate layers 22, 30 needed to meet required roofing material performance codes such as impact and fire resistance.

This weatherable top layer 14 includes a specialized compound that works in concert with the specialized compounds of the semi-weatherable substrate layers 22, 30 that can be injection molded, extruded and bonded, laminated, or multi-layer-extruded. The weatherable top layer 14 is a weatherable polymer or copolymer with resistance to weathering, impact, aging and yellowing.

Further, the weatherable top layer 14 used in this invention as described herein has specific additives that other weatherable materials do not have. These additives impart resistance to UV, weathering, heat aging, high mechanical strength, impact resistance, fire retardance and corrosion resistance.

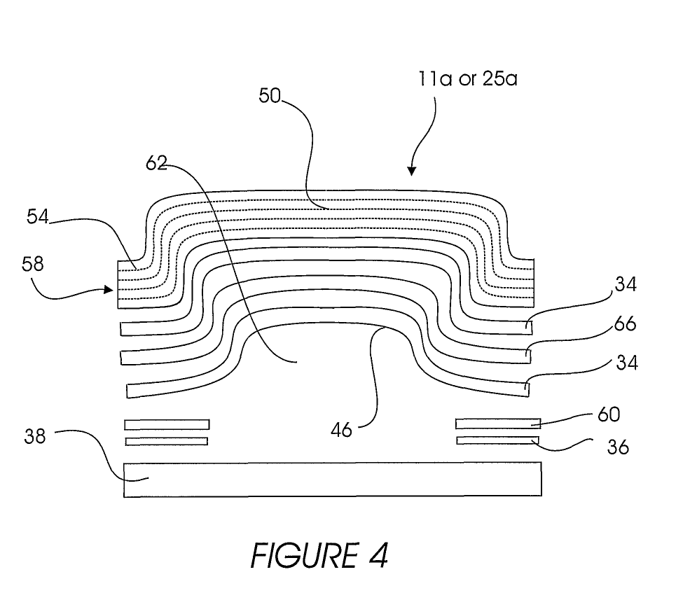

FIG. 5 is a sketch illustrating, in exaggerated cross-section, the special alternate embodiment in which the fire-retardant/resistant fire foam layer 66 or one of the substrate layers 22, 30 (when made of foam) is shaped to have a thick central portion 86. The layers 78 above the specially shaped foam layer 22, 30 or 66 are as described above. In addition the layer 34 or 74 below the foam 22, 30 or 66 is applied so as to fully encapsulate the foam layer 22, 30 or 66. The layer 34 or 74 is made of intumescent fire retardant as described below, or the same semi-weatherable materials as described below other than foam.

The weatherable top layer 14 is a specially formulated polymer made up of several monomers and/or copolymer and was designed to be flexible because of its molecular structure.

There are a limited number of materials that provide a clear weatherable film such as polycarbonate, PMMA and acrylic plastic. The drawback for the use of such materials is compatibility, cost and durability. The present invention has overcome these issues by inventing composites of the said weatherable top layer materials including Acrylonitrile/Styrene/Acrylate (ASA) or PVC or PC copolymer for the top layer of the present invention for certain applications where an acrylic resin or an ASA would not be applicable on their own. Specifically, ASA is an excellent weatherable capsheet although it is not clear to reveal coloration designs such as shake or tile from and on the under surface. Acrylic is an excellent clear weatherable capsheet, although higher in cost as compared to an ASA, where the ASA has superior weatherable properties to Acrylic. Therefore in certain color designs, weather and cost applications, the glass transparency is not as critical. Thus the copolymer of any of the weatherable top layers can have cloudiness to the point of showing through the coloration designs on the under side of the copolymer. Considerable research and development was necessary to find a reflective index balance, equal phasing, neutralizing color toners for the needed clarity and durability of the weatherable top layers and to meet ICC requirements. Never before have these weatherable top layer copolymers been used in a roofing application.

It was discovered that these weatherable top layer copolymers can be designed to have refractive index ratio (velocity of light in a vacuum to its velocity in a substance). This was measured using the ratio of the sine of the angle of incidence to the sine of the angle of refraction to find a reflective balance to find clarity when creating the copolymer formulation. For example, in some applications a ratio of 20% ASA and 80% Acrylic was applicable, whereas the reverse was true in other coloration applications of 80% ASA and 20% Acrylic was applicable. Refractive index was measured by a process specified in ASTM D542.

Therefore, dependent upon the coloration application, lower indexes (1.375) of refraction were used to reduce surface or back reflection and are desirable for certain applications. For example, high indexes of refraction tend to correspond to higher brilliance. The refractive indexes of these weatherable top layer copolymers had to be then tied to the three dimensional effect of the coloration to bring out the most realistic three dimensional look on a two dimensional surface. Further, the ASA and PVC has a natural yellow color that needed to be neutralized with a blue toner giving greater clarity in balance with cost and durability.

It was discovered that the refractive index of these weatherable top layer copolymers is a function of the ratio of these polymers. This is a valuable tool for adjusting the appearance of the decorative effects applied to the backside 15 of the top layer 14. In addition, the natural color of the ASA and PVC polymer is a pale yellow. Blue dye is commonly used in transparent polymers to offset this natural color. Adjusting the level of blue dye adds another means to enhance the decorative effects or clarity desired.

Skid and UV resistant materials 12 such as any of the semi-weatherable or weatherable top layer materials can be combined with silica sand and may be applied in a rough manner, such as a course sprayed, to the top surface 13 to add a rough surface to help in the resistance of slipping by foot traffic on the present invention 10, 10a (plastic roofing product) on a roof.

Other ingredients are added to the base polymers of each layer 22, 30. These additives assist in the molding of the Invention, and add important properties to the finished product. These additives include impact modifiers, lubricants, heat stabilizers, pigments, flame retardants, plasticizers and processing aids. The present invention 10, 10a, 11, 11a uses proprietary formulations and ingredients, as listed herein, that are needed to meet roofing material performance codes such as impact and fire resistance. The semi-weatherable substrate layer 22, 30 compounds are specially formulated with flame retardant to provide a substantially flame retardant and flame extinguishing material for the flammable top layer 14.

This present invention 10, 10a has created a unique polymer chain with certain desirable properties so the semi-weatherable substrate layer 22, 30 polymer compounds bond with the weatherable layer 14 polymer compound and have resistance to delaminating, heat, toughness, and flexibility. Most importantly, the layers 14, 22 and 30 can bond without the need of any adhesive. For the reinforcing strength of the substrate layers 22, 30 a continuous filament yam in an open-mesh construction called a scrim 26, may be used for further reinforcement of the structure between layers 22 and 30.

The present invention's substrate layer 22, 30 formulations use additives such as plasticizers, co-stabilizers and heat stabilizers to prevent degradation caused by the high temperatures during processing. Pigments, inks or dyes, generally called colorants can be added to the present invention so that the finished product will be colored throughout. Flame retardants are added to impart good flame retardant properties to the product. Flame extinguishing material is added to the semi-weatherable layer 22, 30 polymer compound specifically to extinguish the flammable weatherable top layer 14. Processing aids and lubricants are used to assist in production and to improve the viscosity of the resin during processing.

The polymer formulations used in the invention have been researched and tested to meet the requirements of AC07 and AC75. Specifically, the specialized formulation of the weatherable top layer 14 was researched and exhaustively tested to work with the semi-weatherable compounds of the substrate layer 22, 30 materials. This top layer 14 is a high density material that has enhanced mechanical properties with special characteristics such as high tensile strength, elongation at break, modulus of elasticity in tension, good impact strength. Also, it has good thermal stability and high Vicat softening temperature. It has good chemical resistance, and resistant to weathering, aging and yellowing. It might not be feasible to bond weatherable materials and semi or non-weatherable films and expect good molecular compatibility as well as to meet stringent building codes. Hundreds of tests were needed and novel thinking to invent formulations of copolymers that could pass these stringent building roofing codes. A weatherable top layer 14 must have special characteristics to work with the material formulations of the semi-weatherable substrate layer 22, 30 material formulation to meet building codes for roofing and pass physical properties tests as indicated below. The present invention passes ICC AC07 & AC75 required ASTM, UBC & UL tests as indicated herein to meet building code requirements:

AC07: Weatherometer A. Tensile Specimens (ASTM G-23), B. Flexural Specimens (ASTM G-

23); Tensile Strength A. Control (ASTM D-638), B. Weathered (ASTM D-638); Flexural Strength A. Control (ASTM D-638), B. Weathered (ASTM D-638); Wind Resistance A. Static Wind Testing; Uplift Bend A. AC-07 (Section 4.4); Penetration A. AC-07 (Section 4.5); Roof Classification A. Class A Burning Brand (ASTM E-108), B. Class A Int. Flame (ASTM E-108), C. Class A Spread-of-Flame (ASTM E-108); Temperature Cycling A. AC-07 (Section 4.9); Wind-Driven Rain A. AC-07 (Section 4.10); Burn Rate A. UBC 2603.6; Ignition Properties A. UBC 2603.6; Infrared Analysis (IR) A. AC-07 (Section 3.2.9.2.1)

AC75: Weatherometer A. AC-75-(Section4.1.1); Tensile Strength A. (ASTM D-638); Flexural Strength A. (ASTM D-2137); Wind Resistance A. Static Wind Testing; Uplift Bend A. AC-75 (Section 4.1.5); Penetration A. AC-75 (Section 4.2.2); Roof Classification A. Class A Burning Brand (ASTM E-108), B. Class A Int. Flame (ASTM E-108), C. Class A Spread-of-Flame (ASTM E-108); Temperature Cycling A. AC-75 (Section 4.2.3); Wind-Driven Rain A. AC-75 (Section 4.2.6); Burn Rate A. UBC 2603.6; Ignition Properties A. UBC 2603.6 The following chart shows the significant test methods used to establish the physical properties requirements for the present invention 10, 10a and the typical properties achieved by said invention 10, 10a:

Adhesive bonding of layers would not pass the ICC required roofing tests. The present invention

10, 10a has overcome this problem by the introduction of a “tie layer” 20. The tie layer 20 is used to tie a non-polar polymer such as a TPO sheet and a polar polymer such as an acrylic film. For example, the tie layer 20 is a co-polymer including an acrylate and ethylene component that will bond with both the top layer 14 and lower substrate layer 22. The top layer 14 of acrylic plastic and tie layer 20 would preferably be co-extruded from a two-layer die and then laminated to the substrate layers 22. The “tie layer” 20 consists of Ethylene Methyl Acrylate Copolymers (EMAC) and/or Ethylene Butyl Acrylate Copolymers resins. These adhere to the top layer 14 and substrate layer 22 as a tie layer 20 between two incompatible materials. The tie layer 20 is made and formulated to be compatible with the incompatible semi-weatherable layer 22. The tie layer 20 is soft, pliable and tough at ambient and freezing temperatures and exhibits excellent environmental stress crack resistance (ESCR). The tie layer polymer is formulated to exhibit high solids fillability and compatibility with the top 14 and substrate layer 22.

It was found that the formulation for the tie layer 20 must be created in a manner to setup an ion exchange with the resins so they are cross-linked polymers. The ion exchange resins that are used to affect such exchanges are of two types: cation exchange and anion exchange resins. By using the two types either singly or in combination the incompatibility of non polar and polar polymers becomes possible when these ions are altered, removed, or recovered. For the tie layer 20 to be effective, the cation exchange resin or substrate 22 and top layer 14 act as a solid organic acid, resinified and containing replaceable hydrogen (or sodium), which will readily release in exchange of any cation (sodium, potassium, ammonium, etc.). Anion exchange resins are resinous organic bases are activated by acid removal and anion exchange. When the copolymer of styrene and divinyl benzene is treated with chlorosulfonic acid, a polymer is produced that has cation-capturing properties because of the free sulfonic acid groups. In dice form, the polymerized product is insoluble during all phases of an ion exchange reaction. The anion exchanges are made by including a chloride-bearing monomer with the styrene divinyl benzene copolymer. When treated with sodium hydroxide, a reaction with a tertiary base gives a salt, which yields a strong, insoluble polymeric hydroxide. The thermoplastic ionomers have ethylene as their major component by contain both covalent and ionic bonds. The ioπomer polymer exhibits very strong interchain ionic forces. The anions hang from the hydrocarbon chain, and the cations are metallic (sodium, potassium, magnesium).

Below are the physical properties of the tie layer 20:

Roofing materials and underlayments are classified by a fire rating system into Class A, B or C. Class A is the most stringent and includes three specific fire tests; burning brand, spread of flame and intermittent flame. Many roofing materials use a system of underlayments in combination with the roofing material to achieve a fire rating such as 30 Ib felt combined with a roofing material. Although the present invention 10, 10a can use a system to gain a class A fire rating, the present invention has also developed a novel application of a special and proprietary application of a fire-retardant/fire-resistant layers applied or attached to the bottom layer. This is in addition to the fire retardants used in the formulations of the other layers.

The present invention has fire retardants in its substrate layers 22, 30 to extinguish flames of the top layer 14. The present invention 10a, 11a can have an additional fire retardant/fire-resistant intumescent layer 34 in the chamber 62 as an alternative to applying underlayments necessary for a Class A fire rating and or increasing the fire protection of the present invention to bring the present invention into compliance with federal, state and local building code requirements. This fire-retardant/fire-resistant intumescent layer 34 is applied to the chamber 62 above the specially shaped foam layer 86. Preferably the layer 34 is applied by spray that could be a two step catalyst epoxy process. When the fire-retardant/fire-resistant intumescent layer 34 is exposed to high heat such as fire, it will expand creating foam to encapsulate the fuel and oxygen of the fire, thus extinguishing the fire.

Alternatively, the fire retardant/fire-resistant intumescent layer 34 is applied to the chamber 62 above specially shaped foam layer 86 and also to the bottom 32, 70 of the specially shaped foam layer 86. The foam layer 86 helps to add impact strength, insulation and another fire barrier. To improve the fire-resistance properties of the present invention, the foam layer 86 is preferably selected from foams such as polyurethane foam, polyurea foam, polystyrene foam, polyethylene foam and PVC foam. The surface of the chamber 62 might have to be prepared and treated with special chemicals prior to the application of the foams for enhanced adhesion. These foams can be applied by filling, spraying, pouring or injecting into the chamber 62 of the roof panels 10a, 11a.

Alternatively, the fire retardant/fire-resistant foam layer 34 is applied to the bottom 32, 70 of the shaped foam layer 86.

In another alternative a layer 76 of specially formulated fire-resistant mineral core is attached in the chamber 62 between the shaped foam 86 and the fire retardant/fire resistant foam 34.

In yet another alternative a layer of fire-retardant/fire-resistant cloth, felt, paper or polymer 60 is attached to the bottom 46 of the fire retardant/fire resistant foam 34 or the encapsulating layer 74.

The fire-retardant/fire-resistant foam layer is filled, poured, injected or sprayed into the chamber or by packing a pre-formed block of high-density fire-retardant/fire-resistant foam in the chamber. In general, foams can be of many forms (physical structure) like a liquid foam, rolls, planks or sheets depending on their densities, the higher the density, the heavier and harder it is. The foams also can be categorized as flexible, rigid, close-celled or open celled.

There are several types of fire retardant/fire resistant grade foams that are compatible with the said weatherable and semi-weatherable layer materials that may include polyurethane foams, polyurea foams, polystyrene foams, polyethylene foams and PVC foams. The polyurethane materials are formed by the reaction of isocyanates and polyols where the Polyurea materials have a chemical reaction between an isocyanate and an amine where Polystyrene, a polymer made from the monomer styrene, a liquid hydrocarbon that is commercially manufactured from petroleum. All these foams and their chemical reactions have been specially formulated to create compatibility with the said semi-weatherable and weatherable layers.

Furthermore, the foams can be impregnated with several fillers such as wood-chips, saw-dust and other fibers including minerals and in-organic fillers such as ceramics including silica, glass fillers (fiber glass, glass wool) either purely in the micron-size range/nano-size range or as a mixture of micron and nano-size fillers.

The specially formulated fire-resistant mineral core layer may consist of several ingredients such as fiber glass, fiber wool, gypsum, wood-chips, saw-dust other fibers including minerals and in-organic fillers such as ceramics including silica, glass fillers (fiber glass, glass wool) either purely in the micron-size range/nano-size range or as a mixture of micron and nano-size fillers. It is applied to the chamber by pouring, injecting, spraying or filling.

The semi-weatherable and weatherable layers surface may have to be modified physically by etching, abrading or roughening its surface and/or pre-treated with special chemicals/solvents prior to application of the foams for enhanced adhesion. These said semi-weatherable foams can be applied by filling, spraying, pouring or injecting into the chamber. The fire-retardant/fire-resistant intumescent layer can be coated or sprayed onto the chamber.

The intumescent layer when applied to a separate fire-retardant/fire-resistant layer like felt, paper, fabric, or polymer may be treated with phosphate salts and coated with other non-combustible materials.

Specifically, in fire conditions, the top 14 and substrate layers 22, 30 interact with the fire-retardant 34 to create a charred block and then the top 14 and substrate layers 22, 30 form a composite with the underlayment 38. The underlayment 38 is then protected by this charred block composite by the fire-retardant layer 34 producing water and gases, which smother the oxygen and confront the flame's energy forcing the dense char to continue to form creating further protection to the underlayment 38 from combustion.

The unique and specific formulations of the semi-weatherable polymers are compounded to interact with the specialized weatherable polymer to bond and be flame retardant. Most important is the ability of the present invention's 10, 10a novel compound of said semi-weatherable polymer and the weatherable polymer to meet building codes such as Underwriters Laboratories Inc. or ICC AC07 & AC75 Evaluation Service, Inc.

The specific ingredients included in the formulation for the weatherable top layer 14 and semi-weatherable substrate layers 22, 30 are listed below:

Suppliers and Formulation Ingredients:

Hoffman Plastic Compounds, Inc. 16616 Garfield Ave. Paramount, Calif. 92723

PH: 323-363-3346; Ingredient: PVC Polyvinyl Chloride Resin, Antimony oxide, Borates

Occidental Chemical Corp. 5005 LBJ Freeway Dallas, Tex. 75244 http://www.oxychem.com PH: 800-578-8880; Ingredient: PVC Polyvinyl Chloride Resin

LG 920 Sylvan Ave. Englewood Cliffs, N.J. 07632 PH: 201-816-2302;

Ingredient: Acrylonitrile/Styrene/Acrylate Polymer (ASA), Acrylonitrile/Butadiene/Styrene (ABS)

Witco Corp. One America Lane Greenwich, Conn. 06831 http://www.witco.com

PH: 800-494-8287; Ingredient: Heat Stabilizer—Mark 1900, Magnesium, Chlorines, Bromines

CP. Hall Co. 311 S. Wacker Dr. Chicago, Ill. 60606 http://www.cphall.com

PH: 800-449-4747; Ingredient: Epoxidized Soya Bean Oil, Phosphate Esters

Henkel Corp. 300 Brookside Ave. Ambler, Pa. 19002 PH: 800-922-0605;

Ingredient: Lubricant—Loxiol HOB 7111, Lubricant—Loxiol G670

Clariant Corp. 4000 Monroe Rd. Charlotte, N.C. 28205 http://www.clariant.com PH: 800-334-2823; Ingredient: Lubricant—WAX E

Allied Signal Inc. 101 Colombia Rd. Morristown, N.J. 07962 http://www.alliedsignal.com

PH: 800-322-2766; Ingredient: Lubricant—AC 316A

Spartech Plastics—Polymer Extruded Products, Inc. 297 Ferry Street Newark, N.J. 07105 http://www.spartech.com, PH. 973-344-2700; Ingredient: Acrylic Plastic, Korad, styrene acrylonitrile copolymers (SAN), Acrylonitrile/Styrene/Acrylate Polymer (ASA)

Spartech Plastics Corporation 14263 Gannet St., La Mirada, Calif. 90638

http://www.spartech.com, PH. 800-557-4338; Ingredient: Acrylic Plastic, Korad, PVC, CPA, styrene acrylonitrile copolymers (SAN), Acrylonitrile/Styrene/Acrylate Polymer (ASA), polycarbonate (PC)

Bayer 100 Bayer Rd. Pittsburgh, Pa. 15205-2000 http://www.bayer.com

PH: 800-662-2927; Ingredient: Acrylonitrile/Styrene/Acrylate Polymer (ASA), Acrylonitrile/Butadiene/Styrene (ABS), styrene acrylonitrile copolymers (SAN)

Eastman Chemical Co. P.O. Box 511 Kingport, Tenn. 37762 PH: 800-327-8626;

Ingredient: Ethylene Methyl Acrylate Copolymers (EMAC), Ethylene Butyl Acrylate Copolymers'

Rohm and Haas Co. 100 Independence Mall W. Philadelphia, Pa. 19106

http://www.rohmhaas.com, PH: 800-356-2402; Ingredient: Impact modifier—KM 33, Processing aide—K120MD, Processing aide—K175, TM-181—Tin Stabilizer, BTA-753—MBS Impact Mo, K400, Paraloid K-435L—Acrylic Processing Aid, F-1070—Ester Lube, E-2100—Ester Lube, CaSt—Stabilizer Lubricate, Omya UFT—Treated Calcium Carbonate, Wax 165—Int. Ext Lube, Wax 280—Int. Ext Lube, AC629 A—Ext. Lube Oxidized polyethylene, B-3314 Impact Modifier, HT 100 acrylic, Colorants, Ink

Dupont Co. Titanium Dioxide P.O. Box 80036 Wilmington, Del. 19880

http://www.dupont.com PH: 800-441-9485; Ingredient: Pigments—R 101 (TI02), Ketone ethylene ester and ethylene interpolymer, thermoplastic polyolefin (TPO), thermoplastic elastomers (TPE), Polypropylene (PP), Elvaloy Plasticizer

Anzon Inc. 2545 Aramingo Ave. Philadelphia, Pa. 19125 http://www.anzon.com

PH: 800-523-0882; Ingredient: Flame Retardant—Sb2O3/Antimony Oxide, Bromines

Alcan Chemicals 3690 Orange Place, Ste. 400 Cleveland, Ohio 44122 PH: 800-321-3864;

Ingredient: Flame Retardant—Flame Tards Zinc Tin Oxide/ZnSnO3, Alumina Trihydrate Cyro Industries Inc. 100 Enterprise Dr., 7th Floor Rockaway, N.J. 07866 PH: 201-442-6000;

Ingredient: Acrylic Plastic

GE Plastics One Plastics Ave. Pittsfield, Mass. 01201 http://www.geplastics.com PH:

800-255-8886; Ingredient: Acrylonitrile/Styrene/Acrylate Polymer (ASA) & XTW ASA, Acrylonitrile/Butadiene/Styrene (ABS), Poiyphenylene (PPO), polycarbonate (PC)

BP Performance Polymers, Inc. Phenolic Business 60 Walnut Ave., Suite 100 Clark, N.J. 07066 PH: 908-815-7843; Ingredients: Acrylonitrile/Styrene/Acrylate Polymer (ASA), Acrylonitrile/Butadiene/Styrene (ABS)

Americhem Corporation 1300 Fort Worth St. Mansfield, Tex. 76063 PH: 800-433-7608; Ingredients: Colorants; Pigments, Dyes, Inks

Fina Oil PO Box 2159, Dallas, Tex. 75221 PH: 800-344-3462 Ingredients: Styrene butadiene styrene (SBS)

Crompton Corporation—Uniroyal Chemical 199 Benson Road, P.O. Box 846, Middlebury, Conn. 06749 (800) 243-3024. Ingredients: ethylene propylene diene terpolymer (EPDM)

Union Carbide Corp. 39 Old Ridgebury Rd. Danbury, Conn. 06817-0001 800-335-8550 Ingredients: Polyethylene (PE)

Polythane Systems Inc. PO Box 1452 Spring, Tex. 77383-1452; 800-221-3626 Ingredients: fire retardant foams of polyurethane

Advanced Nano Products, Inc., 64 A Houghton Street, Hudson, Mass. 01749; 1-866-460-4111 Ingredients: Intumescence fire retardant materials

Flame Stop.lnα, 924 Bluemound Road, Fort Worth, Tex. 76131; 817-306-1222; Ingredients: Fire-retardant materials

BioCenter, 610 W Rawson Ave, Oak Creek, Wis. 53154; 414-768-7100; Ingredients: fire retardant polyurethane foam

Halstab, 3100 Michigan Street, Hammond, Ind. 46323, 219-844-3980; Ingredients: Heat Stabilzers including co-stabilizers H1214.

Progressive Foam Technologies, Inc, 6753 Chestnut Ridge Road Beach City, Ohio 44608; 1-800-860-3626; Ingredients: Fire-retardant foams of polystyrene Pacor, Inc., 2603 River Road, Suite 1 P.O. Box 2470 Cinnaminson, N.J. 08077; 856-303-8802; Ingredients: Fire-retardant foams of PVC

Clarkfoam Products Corporation, 655 Remington Boulevard Bolingbrook, Ill. 60440; 630-226-5900; Ingredients: Fire-retardant foams of polyethylene The sheet member 10 or 11 can be molded or thermoformed into plastic roofing products 10a,

11a that have a raised central portion 50 and substantially flat lips 54 extending from the edges 58. The product 10a, 11a is installed so that the lips 54 overlap. Thus, when the plastic roofing product 10a, 11a is placed on the roof, the lips 54 lay substantially flat on the roof to define a chamber 62 between the plastic roofing product 10a, 11a and the underlayment 38. The raised central portion 50 does not contact the underlayment 38 and is formed and designed to simulate the appearance of at least one predetermined type of roofing material including but not limited to tile, slate, and wood shake or shingle.

When placed on a roof, the chamber 62 defined by the plastic roofing product 10a, 11a and the underlayment 38 traps a pocket of air that along with the semi-weatherable polymer layer 22 provides good insulation and heat dispersion. Also, when placed on a roof, the bottom layer 22, 30 or 34 faces the roof, and the top layer 14 is exposed to the weather. The composition of the top layer 14 and substrate layer 22 and the unique combination of the layers 14 and 22 offer optimal benefits. The top layer 14, being made of weatherable polymer compounds, has been found to be highly resistant and durable against water as well as the wearing effects of the UV rays of the sun. And the substrate layer 22, being made of specialized semi-weatherable polymer compounds, offers good insulation and has been found to be highly resistant to impact and fire. The semi-weatherable substrate layer 22 is also protected from UV rays by the top layer 14, although the substrate layer 22 has UV protection in case the substrate layer 22 becomes exposed to the sun.

The colorants for the decorative designs are applied to the underside “15, 32 of the top layer 14, 22 by using specific print technology that is tied to corresponding graphic computer software designs. Then, the top layer 14, 22 is laminated to the next substrate layer 18, 20, 22 or 26 with the colorants 16, 17 between the two layers to protect them from the weather. A special formulated colorant is used that bonds and etches into the top layer 14, 22 and is made from special formulated acrylic based colorants with bonding properties and UV properties compatible with the top and substrate materials. In effect the colorants 16, 17 become the second layer. The colorant 16, 17 is compatible with the adjacent layers so as not to cause damage such as delaminating, degradation of layers, color change or other long-term chemical reactions that would cause the material to fail ICC building code requirements.

Preferred decorative designs resemble the three-dimensional appearance of shake, slate or tile for a roofing application. Again, these decorative faux designs have never before been seen in roofing materials for reasons the present invention has overcome by combining specific manufacturing methods, specific industrial print technology, colorant formulation, computer software graphic design, polymer/colorant compatibility, flammability and durability to pass ICC roofing requirements.

The semi-weatherable substrate layers 22, 30 use specialized formulations that may use compatible recycled material and may include scrap, including: polyvinyl chloride (PVC), Acrylonitrile/Styrene/Acrylate polymer (ASA), Acrylic Plastic, polymethyl methacrylate (PMMA), thermoplastic olefin copolymers (TPO) or acrylonitrile butadiene styrene (ABS) or copolymer alloy (CPA) or ethylene propylene diene terpolymer (EPDM) or thermoplastic elastomers (TPE) or styrene butadiene (SB) or rubber or polyethylene (PE) or polypropylene (PP) or specialized fire-retardant/fire-resistant foams that may include polyurethane foam, polyurea foams, polystyrene foams, polyethylene foams and

PVC foams or any of the said weatherable 14 or semi-weatherable layers 22, 30 or other additives that are compatible to the requirements of the formulation to meet building code requirements. The above mentioned foams may be applied by laminating, pouring, filling, injecting or spraying.

The present invention 10, 10a, 11, 11a can be attached to the sheeting over the framing of a roof or to the underlayment 38 on top of the sheeting in a variety of ways. Roofing nails or a double or single sided adhesive peel and stick film can attach the present invention 10, 10a, 11, 11a to the sub surface 38. The overlapping seams of the present invention 10, 10a, 11, 11a may be heat welded when installed on a roof to form a water proof membrane.

The invention 10, 11 includes a decorative faux appearance of dimension, i.e. a three dimensional look, that is actually flat. Thus, when the plastic roofing product 10, 11 is placed on the underlayment 38, the edges and overlap lay substantially flat on the underlayment 38. The flat decorative faux design simulates the appearance of at least one predetermined type of roofing material including but not limited to tile, slate, and wood shake or tile. The appearance can also be made to simulate marble, sea shells, and any fanciful design.

When placed on a roof, the flat plastic roofing substrate layers 22, 30 provide good insulation. Also, when placed on a roof, the bottom layer 22, 30 or 34 faces the underlayment 38, and the top layer 14 is exposed to the weather. The composition of the top layer 14 and substrate layers 22, 30 and the unique combination of the layers offer optimal benefits. The top layer 14, being made of weatherable polymer compounds, has been found to be highly resistant and durable against water as well as the wearing effects of the UV rays of the sun.

Specialized semi-weatherable polymer compounds offer good insulation and have been found to be highly resistant to impact and fire. The semi-weatherable substrate layers 22, 30 are also protected from the UV rays by the top layer 14, although the substrate layers 22, 30 have UV protection in case of the substrate layers 22, 30 become exposed to the sun.

Skid & UV resistant materials 12 such as silica sand coated with any compatible material such as the said weatherable or semi weatherable materials may be applied in a rough manner, such as by course spraying, to the top surface 13, 23 to add a rough surface to help in the resistance of slipping by foot traffic on the present invention 10, 10a, 11, 11a (plastic roofing product) on a roof.

Recently, photovoltaic (solar) panels have been integrated to look like traditional roofing materials such as tiles and shingles by such companies as BIPV, General Electric, PowerLight and Sharp. The present invention 10, 10a, 11, 11a has gone beyond integrating the look of the solar panels with roofing tiles and shingles. The present invention 10, 10a, 11, 11a can incorporate photovoltaic generating film amorphous devices 18 encapsulated under the top layer 14 or semi-weatherable layer 22 for weatherable and natural designs, such as tile and shake. Therefore, the present invention 10, 10a, 11, 11a has utilized its unique coloration designs, UV stability, fire retardant, layer composite and building code approval materials to incorporate a photovoltaic generating system that appears to be the natural look of roofing materials. Where a photovoltaic module 18 may serve as a shingle, tile or other building material such as in Bressler et al U.S. Pat. No. 5,590,495 or Younan et al U.S. Pat. No. 5,437,735, the present invention 10, 10a, 11, 11a is an actual polymeric shingle, tile or other roofing material with photovoltaic generating technology incorporated within the layers of the present invention 10, 10a, 11, 11a 10, 10a, 11, 11a with its advantages and innovations. There is no appearance difference in the roofing materials as is with all other solar, photovoltaic roofing systems. When the present invention 10, 10a, 11, 11a is for used as a photovoltaic panel, electrical connectors are used for connections between each of the present invention's (plastic roofing products) panels. As stated herein, a “tie layer” 20 or some other means may be used to tie the photovoltaic generating device 18 to the substrate layer 22, 26.

A discovery was found to affect lower heat build up in the present invention 10, 10a, 11, 11a. A method to release heat build up in the invention's composite and to mitigate deformation was invented. This was necessary where the use of dark colors on the top layer 14 would have a considerable heat build up, transferring to the substrate 22, 30, as opposed to light colors. Therefore, UV protection is applied to the top layer material and colorants, where Infrared (IR) passes through the top layer 14 to be reflected out by the substrate layer 22, 30. The substrate layer 22, 30 has reflective additives such as TiO₂ to reflect back and out of the composite, keeping the IR from building-up heat in the substrate 22, 30. The present invention 10, 10a has proven that a black substrate will have higher heat build-up than white even through the opacity is 90-100% UV blocked by the weatherable top layer 14. Therefore, a method of reflecting IR through the weatherable materials, colorants and substrate was engineered by the use of materials, reflectants, layering, colorants and by controlling thickness. To prove this theory, the following tests were preformed:

Samples of Roofing Laminates were exposed to two IR lamps. The samples were the streaked blue-gray (Midnight Gray) ASA cap laminated to PVC backing. The backing formulation was that of the present invention 10, 10a with 30% PVC-ASA regrind. The PVC substrate 22 was extruded at 0.070 in. Two backing colors were made—natural (a light beige color) and black. The samples were exposed to the IR Lamps with the light shining on the cap surface 13. Exposure time was one hour. Non-contact contact surface temperature measurements were taken of the front 13 and the back 32 surface at one hour exposure time. Two samples with natural-colored backing and two with black colored backing were exposed. The temperatures reported are averages of the measurements.

Results are:

Cap Surface 13 Temp. Backing Surface 32 Temp.

Natural Backing 191° F. 181° F.

Black Backing 212° F. 200° F.

This test confirms that there is an IR heat buildup with darker color substrates 22, 30, even though not directly exposed by a 90-100% UV block capsheet 14. IR is a type of electromagnetic radiation of wavelengths 700 nm -1 nm longer than visible light, but shorter than microwave radiation. It was discovered that the infrared absorptions or reflections depends a lot on the particle size of the colorants used in the formulation. Therefore, in this scenario, though some of the IR of smaller wavelengths are blocked or absorbed by the colorants present in the top layer 14 due to the fact that IR wavelength is closer to the particle-size of the pigments present, longer wavelengths of IR pass through the top layer 14 with little or no absorption. Therefore the certain percentage of IR that goes through the top layer 14 heats up the substrate layer 22 which absorbs or reflects the radiation that is incident upon it. It was further discovered, that the top layer 14 heats up more than the substrate layer 22 due to the fact that the top layer 14 has a lot of UV blocking colorants like TiO₂ and other metal/metal oxide additives

It was further discovered as the IR passes through the top layer 14, it heats up a black substrate layer 22 more than a white substrate layer as the color black absorbs more heat than white. Also as the substrate layer is heated up, it transfers some of its heat back to the top layer 14 by conduction and therefore you see a difference in temperatures of the top layers 22 with 2 different substrate layers.

### EXAMPLE

Thickness: Plastic roofing products were fabricated in accordance with the above description. The top layer 14 of the weatherable polymer compound was from 0.002 to 0.015 in. thick and the layer 22 of semi-weatherable polymer compound was from 0.010 to 0.125 in. thick before thermoforming. Based on the current design of the plastic roofing product it is estimated that the desirable thickness of the product should between 0.045″ and 0.090″ in roll applications and between 0.045″ and 0.125″ in thermoformed applications.

Size: The thermoformed plastic roofing product sizes experimented with range from Vi′—1.5″ thick by 12″-36″ by 36″-60″. The rolls measure 40″-120″ by 100 ft to 600 ft.

Weight: Dependent upon thickness ranges from 25 pounds to 120 pounds approximately per 100 square feet. This product is one of the lightest weight roofing materials available.

The present invention 10, 10a, 11, 11a can be attached to the sheeting over the framing of a roof or to the underlayment 38 on top of the sheeting in a variety of ways. This includes nail, hot mopping with bitumen or other material. Alternatively, a double-sided adhesive peel and stick film 36 can be attached to the present invention to adhere it to the sub surface.

The plastic roofing product 10, 10a, 11, 11a was tested and passed ICC AC07 & AC75 requirements. The testing included the following acceptance criteria specific to plastic tiles and plastic roofing products: Weatherometer, Wind Resistance, Uplift-bend, Penetration Roof Classification, Temperature-cycling, Wind-driven Rain, Hail, installation over spaced and solid sheathing and quality control tests.

PVC and other polymers are not used in roofing where a certain dimensional shape or dimensional form is needed to be maintained such as in a profile of shake, shingle, slate or tile. This is because some polymers have a lower Heat Deflection Temperature (HDT), than other polymer materials, for example PVC will deform at about 150° F., have color loss and cracking, leading to performance degradation at higher temperatures. Depending upon the color of a roof, darker colors have greater heat absorption. Temperatures on the roof can exceed ambient temperatures by 40° F., or more if the surface is a dark color. Low HDT is common to PVC and therefore heat stabilizing additives are use for protecting and stabilizing the material primarily in the high heat processing of the PVC. With the use of high temperature additives HDT may increase to as much as 155° F. But these temperatures will not allow dark colors in desert regions, which the present invention has overcome by creating a method of increasing HDT in these materials.

The heat deflection temperature (HDT) is the relative measure of a material's ability to perform for a short time at elevated temperatures while supporting load. It is the temperature at which a standard test bar (ASTM D648) deflects 0.010 in. under a flexural load of either 64 psi or 264 psi.

The HDT test simulates only a very narrow range of conditions. Many high-temperature applications involve higher temperatures, greater loading, and unsupported conditions, which is certainly the case with the extreme weather conditions of roofing.

Therefore, the results obtained by this test method do not represent maximum use temperatures, because, in real life, essential factors such as time, loading, and nominal surface stress may differ from the standard test conditions.

To prove the increased HDT, the present invention 10, 10a, 11, 11a was tested for HDT, where a sample is deflected to produce a defined surface stress and then placed in a temperature bath at 23° C. The force is allowed to act for 5 minutes, and then the temperature is raised at a uniform rate of 2° C./min. The deflection of the test bar is continuously observed: the temperature at which the deflection reaches 0.010 in. is reported as the heat deflection temperature.

In an effort to increase the HDT many additives were experimented with but it was found that the higher HDT materials had too high a melt temperature to molecularly combine with the base formulation. A process was discovered to combine materials with different melt rates as described herein. This HDT increasing process was developed to effect fusion of two incompatible materials, whereas the higher HDT material would not affect HDT and would only act as a filler. This method allows the incompatible materials to interact thus increasing HDT.

The present invention 10, 10a, 11, 11a has created a new and innovative process to increase HDT in its substrate layer 22, 30 formulation polymers so the polymer can be used in dimensional shapes of roofing applications with dark colors in high temperature regions of about 110° F. ambient.

Using the PVC substrate layer 22, 30 formulation as an example, this is accomplished by the following:

The substrate layers 22, 30 of the PVC formulation are specifically compounded with the ingredients listed herein. The PVC compound is extruded at between 325° F. and 425° F. to gain annealed qualities or can be compatible recycled materials. Up to 50% of this extruded and annealed PVC compound is added to less annealed or virgin compounded PVC. Then either alone or combined acrylic-styrene-acrylonitrile (ASA) or acrylic plastic or acrylonitrile-butadiene-styrene copolymer (ABS) or polycarbonate (PC) are extruded between 375° F. and 450° F. Then these materials are combined totaling up to 25% of this extruded material and then up to 50% of the previously extruded PVC compound is added to the virgin or virgin regrind compounded PVC that has not been extruded or has only one history of heat such as extrusion, then all these materials are extruded into rolls or sheets or the combined materials may be injection molded. The sheets can be thermoformed to add more heat history. Each step of this process yields greater HDT for the substrate layers of the PVC formulation or other substrate layer 22, 30 material. Although, if the material became to processed, heat stability would be lost making the material unusable. Therefore, it was necessary to establish Brabender Stability Tests Results to maintain a balance of HDT and stability of the material.

A number of Brabender Stability Tests were preformed, as indicated below, because it was found that in order to pass required building code tests and physical properties tests (A-H) the minutes to degradation of the materials used needs to exceed 26 minutes and the equilibrium torque needs to be below 1600 meter grams.

Other substrate layers 22, 30 formulations can be used and are interchangeable. The PVC formulation is particular additives such as acrylic-styrene-acrylonitrile (ASA) or acrylic plastic or acrylonitrile-butadiene-styrene copolymer (ABS) or polycarbonate (PC).

Another problem of polymer type roofing products includes the loss of HDT over time. The present invention has overcome this by engineering the semi-weatherable formulation to react to natural environmental temperature cycling, thus the material becoming annealed from this process and resulting in increased HDT. Thus the present invention 10 was designed to continually increase HDT over time stimulated by the natural effect of temperature cycling on roofing product. The semi-weatherable material was formulated and the said method of increasing HDT as the material is exposed to the effects of natural temperature cycling of weather, such as exposure on a roof. The semi-weatherable material was formulated to begin annealing over 50° C., thus continually increasing HDT over time. This was accomplished by two separate processes. First, by the increasing HDT method described above and then second by specifically balancing the physical properties of each formulation component to affect a compatible relationship to its Vicat, inherent viscosity, stability and torque.

For the first time, the present invention 10, 10a, 11, 11a has overcome problems by developing a process of creating decorative or faux designs to resemble such roofing materials like wood grain, marble, shake, slate and tile, in a weatherable manner to achieve the required roofing building code performance requirements, including fire retardancy.

Most colorants are introduced into the base material and give an overall color to the material as is the case in this present invention. The present invention 10, 10a, 11, 11a created an additional process, specific for roofing materials, using colorant particles that have been engineered to maintain their integrity, without completely blending in the base color or repelling the base color and then melting or disseminating creating a “streaking effect” looking like marble or wood grain. These colorant particles vary in size, hardness, melt temperature and color, and are engineered to create specific effects. These colorant particles combine with the other materials while traveling through the screw in the extruder to the die lips.

The present invention 10, 11 also created another process of coloration to resemble a greater number of three dimensional natural designs such as wood grain, tile, slate, sea shells, leaves and marble looks for a roofing application. The colorants used are compatible with the top layer 14 and substrate layers 22, 30-of material, are UV resistant and do not to affect roofing requirements, such as flammability or bonding. The colorants are protected from weathering by the encapsulation of the layer 16 of colorants between the first layer 14 and adjacent layer 18, 20, or 22 without affecting the decorative design in the lamination or extrusion process. Thus, decorative and faux designs are processed on the underside surface 15 of the top layer 14 material to be bonded, preferable by extrusion heat in a molecular bond, to the adjacent layer, so as to not expose the colorants to the weather but still be able to see the encapsulated decorative and faux designs through the clear top layer 14. The colorants for the decorative designs are applied to the underside surface 15 of the top layer 14 by using some print method such as flexographic, inkjet or rotogravure printing. Then, the top layer 14 is laminated to the substrate layers 18, 20 or 22 with the colorant layer 16 encapsulated. This protects the decorative designs resembling wood grain, marble or slate for a roofing application. By special process, these decorative designs appear three-dimensional and have never been seen before in roofing materials.

Generally UV block spray sealers are used to help prevent UV material degradation; this is not applicable for the harsh environment of a roof. For the first-time a UV multi layering method of protecting the coloration design such as shake, tile or slate from UV material degradation has been formulated in colored, clear and opaque materials in the following manner. The first step of the process is accomplished by adding/blending UV protection, such as titanium dioxide or carbon black, into the substrate layers 22, 30, then by adding UV stable colorant on the substrate layers 22, 30 if needed in the design, then by applying colorants to the underside surface 15 of the top layer 14 to also protect the substrate layers 22, 30 and whereby applying colorants to the top layer 14, the colorants are encapsulated between the substrate layers 22 or 30 and the top layer 14. Further, the clear top layer 14 provides UV protection for the layer of colorants 16 applied to the underside surface 15 of the top layer

14. It is this unique and novel multi layering method, blending and encapsulating of UV protection that yields coloration that is resistant to color fade and color change. This innovation has never been used in roofing materials.

It was discovered that encapsulating the specific colorants 16, 17 between the weatherable top layer materials 14 and substrate layer materials 22 under heat and then annealing the composite materials creates an encapsulation superior to spray coatings or simple encapsulation. Further, the colorants have been formulated with pigments with low levels of oxidation materials. This encapsulation is further sealed by the impermeable weatherable top layer material 14 that is exposed to the environment. QUV testing showed significant preservation against color fade and degradation of physical properties of the overall composite.

For the first time fire-retardant coatings are applied to the bottom layer 22 or 30 to form a fire-retardant roofing material meeting building code requirements. The fire-retardant layers 34 works by suppressing flame through intumescence. This means the materials puff up on exposure to flame or excessive heat, solidifying into rigid foam. This foam insulates the substrate layer 22 or 30 from the flame. Never before has this process been applicable to a roofing material because of compatibility and weathering issues of materials. The present invention has overcome this by using a proprietary flame retardant two-part epoxy layer creating a forceful adherent fire retardant block. In fire condition applied to the top surface 13, the top layer 14 and substrate layers 22, 30 interact with the fire retardant to create a charred block under fire. Then the top layer 14 and substrate layers 22, 30 fall on the underlayment 38. The underlayment 38 is then protected by the charred block, working in concert with the underlayment 38. The fire-retardant layer 34 has high moisture content and produces water and gases, which smother the oxygen and confront the flame's energy forcing a dense char to form creating further combustion protection for the underlayment 38. The fire-retardant layer 34 can be applied by spray or as a film lamination to the bottom layer 22 or 30. The bottom layer 22 or 30 to which the fire-retardant layer 34 is adhered, is specifically formulated in combination with the fire-retardant to be molecularly bonded when adhered so as not to delaminate in the extreme conditions of roofing weathering. The fire-retardant layer 34 becomes the bottom layer. The flame retardant intumescent formula that has antimony oxide and epoxy resin is produced by the condensation reaction of epichlorhydrin and bisphenol-A. Phosphorus compounds are used to remove the carbon fuel source and provide an insulation layer against the fire's heat. Metal hydrates such as aluminum trihydrate (ATH) or magnesium hydroxide remove heat by using it to evaporate water in their structure. More specifically, these materials are used in the nanosize range (1-100 nm) and particles in these dimensions are used to create the composite to be applied by spray or a film layer.

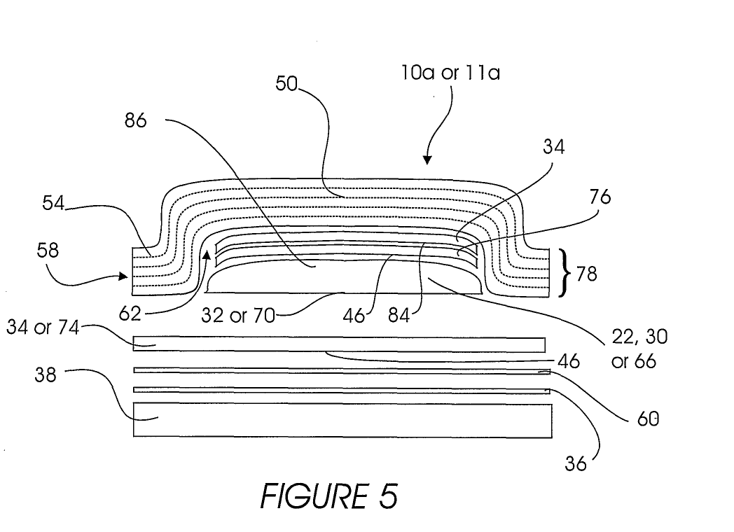

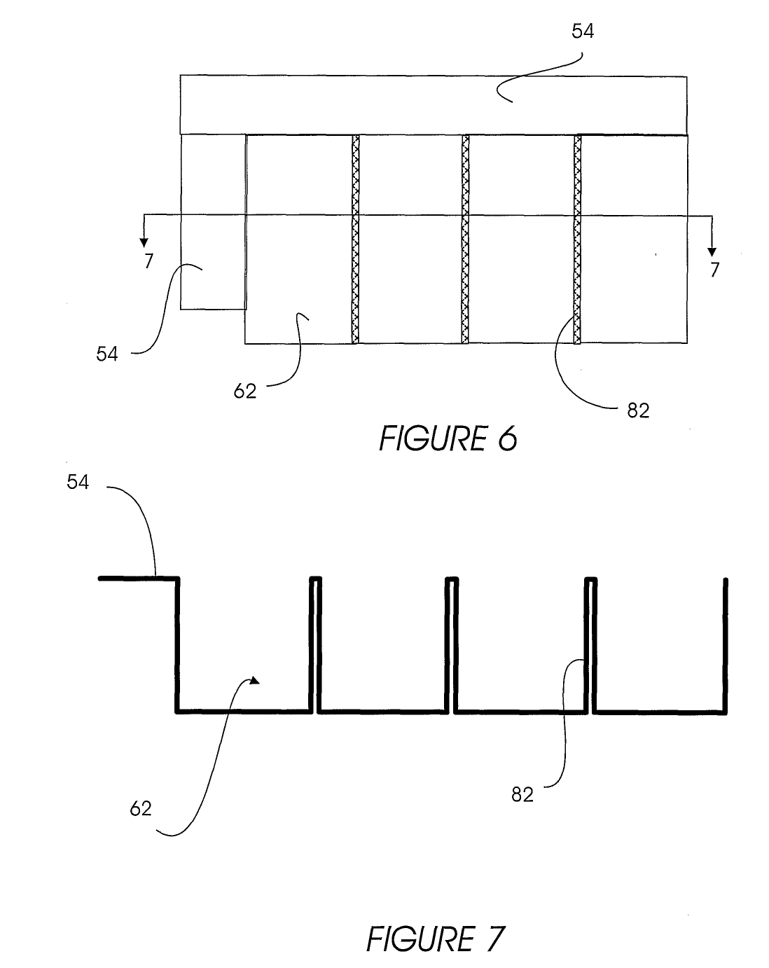

FIGS. 6 and 7 illustrate that the thermoformed embodiments 10a, 11a of this invention are more typically fabricated in units with several chambers 62 with lips on 54 on two sides and a ridge 82 separating each chamber 62. Each chamber is about 0.5 inch deep. In this way each unit can be installed on a roof so that the lips 54 overlap in order to provide a good seal. The present invention has overcome the long-term (30-50 years) weatherablity issues with roofing materials, although the demand for less expensive short-term (10-25 years) semi-weatherable roofing materials serves a market segment. Thus, the present invention with all of its methods and processes as indicated herein can be applied to the semi-weatherable materials without the use of the weatherable top layer materials for roofing applications.

The following reference numerals are used in FIGS. 1-7:

10 preferred embodiment of invention

10a thermoformed preferred embodiment of invention

11 alternate embodiment of invention

11a thermoformed alternate embodiment of invention

12 optional skid proof layer

13 top of top layer

14 top layer of weatherable plastic

15′ bottom of top layer

16 optional first or only layer of colorant

17 optional second or only layer of colorant

18 optional photovoltaic layer

19 top of photovoltaic layer

20 optional tie layer

21 top of tie layer

22 substrate layer of semi-weatherable plastic

23 top of substrate layer

25 second alternate embodiment of invention

25a thermoformed version of second embodiment of invention

26 optional scrim layer

30 optional second substrate layer 31 top of layer of photovoltaics

32 bottom of substrate layer

34 optional fire-retardant/fire-resistant iniumescent fire layer (applied after extrusion or thermoforming)

36 optional adhesive

38 underlayment

42 base of preferred embodiment

44 base of alternate embodiment

46 bottom of intumescent fire layer

50 central portion of formed product

54 substantially flat lip

58 edge of flat lip

60 optional fire-retardant/fire-resistant cloth, felt, paper or polymer layer (coated with intumescent)

62 chamber

66 optional fire-retardant/fire-resistant foam layer

70 bottom of foam layer

74 encapsulating layer

76 optional specially formulated fire-resistant mineral core layer

78 layers above specially shaped foam layer

82 ridge dividing multiple chambers

84 bottom of specially formulated fire-resistant mineral core layer

86 thick central portion

While a preferred embodiment of the present invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

What is claimed is:

1. A roofing product in combination with a roof comprising:
a top layer made of weatherable plastic; said weatherable plastic including additives which impart stability against UV light, thermal aging resistance, resistance to impact, resistance to weathering and dimensional stability;
a middle layer made from UV resistant colorant; and
a base layer comprising a substrate layer made of semi-weatherable plastic; said semi-weatherable plastic being formulated with at least one flame retardant to impart flame retardancy and flame extinguishment properties for said roofing product and including additives which impart stability against UV light, thermal aging resistance, resistance to impact, resistance to weathering and dimensional stability, and infrared refectivity;
said layers bonded together;
said layers formulated so said roofing product a) has a heat distortion temperature of 150-300° F. at 264 psi and b) meets requirements of International Code Council Acceptance Criteria 07 and 075.

2. A roofing product in combination with a roof comprising:
a base layer comprising a substrate layer made of semi-weatherable plastic; said semi-weatherable plastic being formulated with at least one flame retardant to impart flame retardancy and flame extinguishment properties for said roofing product and including additives which impart stability against UV light, thermal aging resistance, resistance to impact, resistance to weathering and dimensional stability, and infrared reflectivity; said semi-weatherable plastic also including UV resistant colorant;
said layer formulated so said roofing product a) has a heat distortion temperature of 150-300° F. at 264 psi and b) meets requirements of International Code Council Acceptance Criteria 07 and 075.

3. A roofing product in combination with a roof comprising:
a top layer made of weatherable plastic; said weatherable plastic including additives which impart stability against UV light, thermal aging resistance, resistance to impact, resistance to weathering and dimensional stability; said weatherable plastic also including UV resistant colorant; and
a base layer comprising a substrate layer made of semi-weatherable plastic; said semi-weatherable plastic being formulated with at least one flame retardant to impart flame retardancy and flame extinguishment properties for said roofing product and including additives which impart stability against UV light, thermal aging resistance, resistance to impact, resistance to weathering and dimensional stability, and infrared reflectivity;
said layers bonded together;
said layers formulated so said roofing product a) has a heat distortion temperature of 150-300° F. at 264 psi and b) meets requirements of International Code Council Acceptance Criteria 07 and 075.

4. A roofing product in combination with a roof as claimed in claims 1, 2 or 3, further comprising a tie layer bonded between said top layer and said base layer.

5. A roofing product in combination with a roof as claimed in claim 4 in which said tie layer is selected from the group consisting of ethylene methyl acrylate copolymer (EMAC), butyl acrylate copolymer and their mixtures.

6. A roofing product in combination with a roof as claimed in claims 1, 2 or 3 in which said base layer further comprises a scrim layer and a second substrate layer made from said semi-weatherable plastic.

7. A roofing product in combination with a roof as claimed in claims 1, 2, 3, 4 or 6 in which said base layer further comprises a layer of intumescent fire retardant/fire resistant.

8. A roofing product in combination with a roof as claimed in claims 1, 2, 3, 4 or 6 in which said base layer further comprises a layer of fire retardant/fire resistant foam.

9. A roofing product in combination with a roof as claimed in claim 8 in which said fire retardant/fire resistant foam is selected from the group consisting of polyurethane foam, polyurea foam, polystyrene foam, polyethylene foam and PVC foam.

10. A roofing product in combination with a roof as claimed in claim 8 in which said base layer further comprises a second layer of intumescent fire retardant/fire resistant.

11. A roofing product in combination with a roof as claimed in claims 1, 2, 3, 4, 6, 7, 8 or 10 further comprising a layer of photovoltaic generating film bonded to said top layer.

12. A roofing product in combination with a roof as claimed in claim 1, 2 or 3 in which said additive which imparts stability against UV light is selected from the group consisting of titanium dioxide and carbon black.

13. A roofing product in combination with a roof as claimed in claims 1, 2, 3, 4, 6, 7, 8, 10 or 11 further comprising a layer of adhesive applied to the bottom of said base layer.

14. A roofing product in combination with a roof as claimed in claim 1 or 3 in which said weatherable plastic is selected from the group consisting of acrylic plastic; polymethyl methacrylate (PMMA); acrylonitrile/styrene/acrylate polymer (ASA); polycarbonate (PC); polyvinylchloride (PVC); and a mixture of said weatherable plastic materials.

15. A roofing product in combination with a roof as claimed in claim 1 or 3 in which said weatherable plastic includes at least one colorant.

16. A roofing product in combination with a roof as claimed in claim 1, 2 or 3 wherein said plastic further includes disbursed colorant particles which are designed to spread at processing speed and temperatures; whereby said colorant particles produce a decorative pattern as said plastic is processed into said layer.

17. A roofing product in combination with a roof as claimed in claim 1, 2 or 3 in which said colorant is applied so as to provide a three dimensional effect resembling a natural product.

18. A roofing product in combination with a roof as claimed in claims 1 or 3 in which said UV resistant colorant is made from materials miscible with the top and substrate layer.

19. A roofing product in combination with a roof as claimed in claim 1, 2 or 3 in which said UV resistant colorant is designed to etch and bond to the layer to which it is applied.

20. A roofing product in combination with a roof as claimed in claims 1, 2 or 3 in which said UV resistant colorant is UV and IR reflective.

21. A roofing product in combination with a roof as claimed in claim 1, 2 or 3 wherein said top layer is clear.

22. A roofing product in combination with a roof as claimed in claims 1, 2 or 3 in which said semi-weatherable plastic is formulated with UV and IR reflective materials.

23. A roofing product in combination with a roof as claimed in claims 1, 2, 3 or 22 in which said additive which imparts IR reflectivity is titanium dioxide.

24. A roofing product in combination with a roof as claimed in claims 1, 2 or 3 in which said semi-weatherable plastic is thermally processed so as to increase the heat deflection temperature of said substrate layer.

25. A roofing product in combination with a roof as claimed in claims 1, 2, or 3 in which said semi-weatherable plastic is formulated with a light color so as to provide infrared reflective properties for said roofing product, whereby heat is deflected from said roofing product.

26. A roofing product in combination with a roof as claimed in claims 1, 2 or 3 in which said weatherable and semi-weatherable plastics are formulated to anneal at temperatures just over 50° C. whereby HDT continually increases by the natural effect of temperature cycling of said roofing product.

27. A roofing product in combination with a roof as claimed in claim 7 or 10 in which said intumescent fire retardant/fire resistant includes materials selected from the group consisting of phosphorus compounds, aluminum trihydrate and magnesium hydroxide.

28. A roofing product in combination with a roof as claimed in claim 27 in which said materials are of a size selected from the group consisting of nanoparticles, micron sized particles and mixtures of nanoparticles and micron sized particles.

29. A roofing product in combination with a roof as claimed in claim 7 or 10 in which said intumescent fire retardant/fire resistant includes epoxy resin.

30. A roofing product in combination with a roof as claimed in claims 1, 2 or 3 further comprising a skid resistant coating applied to the top surface of said roofing product.

31. A roofing product in combination with a roof as claimed in claim 30 in which said skid resistant coating is also UV resistant.

32. A roofing product in combination with a roof as claimed in claim 30 in which said skid resistant coating is UV and IR reflective.

33. A roofing product in combination with a roof as claimed in claim 30 in which said skid resistant coating is silica sand coated with a compatible adhesive polymer.

34. A roofing product in combination with a roof as claimed in claims 1, 2, 3 or 6 in which said semi-weatherable plastic is selected from the group consisting of acrylic; high impact polystyrene (HIP); polyethylene terephthalate (PET) modified with cyclohexanedimethanol (CHDM); polycarbonate (PC); acrylonitrile/styrene/acrylate polymer (ASA); polyvinylchloride (PVC); copolymer alloy (CPA); thermoplastic olefin copolymers (TPO); acrylonitrile butadiene styrene (ABS); ethylene propylene diene terpolymer (EPDM); thermoplastic elastomers (TPE); polyethylene (PE); polypropylene (PP); polyurethane foam (PU) and mixtures of said semi-weatherable plastic materials.

35. A roofing product in combination with a roof as claimed in claims 1, 2, or 3 in which said layers are bonded with heat and subsequently annealed to provide enhanced resistance to oxidation for said roofing product.

36. A roofing product in combination with a roof as claimed in claim 2 or 3 in which said roofing product is further annealed.

37. A roofing product in combination with a roof as claimed in claim 2 or 3 in which said roofing product is formed to have a raised central portion and a flat lip whereby a chamber is defined.

38. A roofing product in combination with a roof as claimed in claim 37 in which said chamber traps a pocket of air, thus increasing insulation of said roofing product.

39. A roofing product in combination with a roof as claimed in claim 37 in which said chamber is filled with a material selected from the group consisting of polyurethane foam, intumescent fire retardant/fire resistant, and fire retardant/fire resistant foam.

40. A roofing product in combination with a roof as claimed in claim 39 further comprising a fire retardant/fire resistant mineral core layer above said fire retardant/fire resistant foam layer.

41. A roofing product in combination with a roof as claimed in claim 40 in which said fire-resistant/fire retardant mineral core layer comprises materials selected from the group consisting of fiber glass, glass wool, gypsum, wood-chips, saw-dust, silica, glass fillers and their mixtures.

42. A roofing product in combination with a roof as claimed in claim 38 further comprising an encapsulating layer below and bonded to the foam in said chamber; said encapsulating layer selected from the group consisting of semi-weatherable plastic and intumescent foam.

43. A method of fabricating a roofing product in combination with a roof comprising the steps of:
obtaining weatherable plastic;
obtaining semi-weatherable plastic;
obtaining UV resistant colorant;
formulating said weatherable plastic with additives which impart stability against UV light, thermal aging resistance, resistance to impact, resistance to weathering and dimensional stability; and formulating said semi-weatherable plastic with at least one flame retardant to impart flame retardancy and flame extinguishment properties for said roofing product and with additives which impart stability against UV light, thermal aging resistance, resistance to impact, resistance to weathering and dimensional stability, and infrared reflectivity; so that said roofing product a) has a heat distortion temperature of 150-300° F. at 264 psi and b) meets requirements of International Code Council Acceptance Criteria 07 and 075;
fabricating said formulated weatherable plastic into a top layer;
fabricating said formulated semi-weatherable plastic into a base layer;
applying said UV resistant colorant to one of said top layer and said base layer; and
bonding said layers together so that said UV resistant colorant is between said layers.

44. A method of fabricating a roofing product in combination with a roof comprising the steps of:
obtaining semi-weatherable plastic;
formulating said semi-weatherable plastic with: at least one flame retardant to impart flame retardancy and flame extinguishment properties for said roofing product, UV resistant colorant and additives which impart stability against UV light, thermal aging resistance, resistance to impact, resistance to weathering and dimensional stability, and infrared reflectivity for said weatherable plastic; so that said roofing product a) has a heat distortion temperature of 150-300° F. at 264 psi and b) meets requirements of International Code Council Acceptance Criteria 07 and 075;
fabricating said formulated semi-weatherable plastic into a base layer.

45. A method of fabricating a roofing product in combination with a roof comprising the steps of:
obtaining weatherable plastic;
obtaining semi-weatherable plastic;
obtaining UV resistant colorant;
formulating said weatherable plastic with additives which impart stability against UV light, thermal aging resistance, resistance to impact, resistance to weathering and dimensional stability; and formulating said semi-weatherable plastic with at least one flame retardant to impart flame retardancy and flame extinguishment properties for said roofing product and with additives which impart stability against UV light, thermal aging resistance, resistance to impact, resistance to weathering and dimensional stability, and infrared reflectivity; so that said roofing product a) has a heat distortion temperature of 150-300° F. at 264 psi and b) meets requirements of International Code Council Acceptance Criteria 07 and 075;
fabricating said formulated weatherable plastic into a top layer;
fabricating said formulated semi-weatherable plastic into a base layer; and
bonding said layers together.

46. A method as claimed in claims 43, 44 or 45, further comprising the steps of:
providing a tie layer; and
bonding said tie layer between said top layer and said base layer.

47. A method as claimed in claim 46 in which said tie layer is selected from the group consisting of ethylene methyl acrylate copolymer (EMAC), butyl acrylate copolymer and their mixtures.

48. A method as claimed in claims 43, 44 or 45 further comprising the steps of:
providing a scrim;
fabricating said formulated semi-weatherable plastic into a second substrate layer;
bonding said scrim to the bottom of said base layer; and
bonding said second substrate layer to said scrim.

49. A method as claimed in claims 43, 44, 45, 46 or 48 further comprising the steps of:
providing intumescent fire retardant/fire resistant; and
bonding a layer of said intumescent fire retardant/fire resistant so said base layer.

50. A method as claimed in claims 43, 44, 45, 46 or 48 further comprising the steps of:
providing fire retardant/fire resistant foam; and
bonding a layer of said fire retardant/fire resistant foam to said base layer.

51. A method as claimed in claim 50 in which said fire-retardant/fire resistant foam is selected from the group consisting of polyurethane foam, polyurea foam, polystyrene foam, polyethylene foam and PVC foam.

52. A method as claimed in claim 51 further comprising the steps of:
providing intumescent fire retardant/fire resistant; and
bonding a layer of said intumescent fire retardant/fire resistant so said fire retardant/fire resistant foam.

53. A method as claimed in claims 44, 45, 46, 47, 49, 50, 51 or 52 further comprising the steps of:
providing photovoltaic generating film;
bonding a layer of said photovoltaic generating film to said top layer.

54. A method as claimed in claim 44, 45 or 46 in which said additive which imparts stability against UV light is selected from the group consisting of titanium dioxide and carbon black.

55. A method as claimed in claims 44, 45, 46, 47, 49, 50, 51, 52 or 53 further comprising the steps of:
providing an adhesive;
and bonding a layer of adhesive to the bottom of said roofing product.

56. A method as claimed in claim 44 or 46 in which said weatherable plastic is selected from the group consisting of acrylic plastic; polymethyl methacrylate (PMMA); acrylonitrile/styrene/acrylate polymer (ASA); polycarbonate (PC); polyvinylchloride (PVC); and a mixture of said weatherable plastic materials.

57. A method as claimed in claim 44 or 46 in which said weatherable plastic includes at least one colorant.

58. A method as claimed in claim 44, 45 or 46 wherein said plastic formulation further includes disbursed colorant particles which are designed to spread at processing speed and temperatures; whereby said colorant particles produce a decorative pattern as said plastic is fabricated into said layer.

59. A method as claimed in claim 44, 45 or 46 in which said colorant layer is fabricated so as to provide a three dimensional effect resembling a natural product.

60. A method as claimed in claims 44, 45 or 46 in which said UV resistant colorant is made from materials miscible with the top and substrate layers.

61. A method as claimed in claim 44, 45 or 46 in which said UV resistant colorant is designed to etch and bond to the layer to which it is applied.

62. A method as claimed in claims 44, 45 or 46 in which said UV resistant colorant is UV and IR reflective.

63. A method as claimed in claim 44, 45 or 46 wherein said top layer is clear.

64. A method as claimed in claims 44, 45 or 46 in which said semi-weatherable plastic is formulated with UV and IR reflective materials.

65. A method as claimed in claims 44, 45, 46 or 64 in which said additive which imparts IR reflectivity is titanium dioxide.

66. A method as claimed in claims 44, 45 or 46 further comprising the step of thermally processing said semi-weatherable plastic so as to increase the heat deflection temperature of said base layer.

67. A method as claimed in claims 44, 45, or 46 in which said semi-weatherable plastic is formulated with a light color so as to provide infrared reflective properties for said roofing product, whereby heat is deflected from said roofing product.

68. A method as claimed in claims 44, 45 or 46 in which said weatherable and semi-weatherable plastics are formulated to anneal at temperatures just over 50° C. whereby HDT continually increases by the natural effect of temperature cycling of said roofing product.

69. A method as claimed in claim 50 or 52 in which said intumescent fire retardant/fire resistant includes materials selected from the group consisting of phosphorus compounds, aluminum trihydrate and magnesium hydroxide.

70. A method as claimed in claim 69 in which said materials are of a size selected from the group consisting of nanoparticles, micron sized particles and mixtures of nanoparticles and micron sized particles.

71. A method as claimed in claim 50 or 52 in which said intumescent fire retardant/fire resistant includes epoxy resin.

72. A method as claimed in claims 44, 45 or 46 further comprising the steps of:
providing a skid resistant coating; and
applying said skid resistant coating to the top surface of said roofing product.

73. A method as claimed in claim 72 in which said skid resistant coating is also UV resistant.

74. A method as claimed in claim 72 in which said skid resistant coating is UV and IR reflective.

75. A method as claimed in claim 72 in which said skid resistant coating is silica sand coated with a compatible adhesive polymer.

76. A method as claimed in claims 44, 45, 46 or 49 in which said semi-weatherable plastic is selected from the group consisting of acrylic; high impact polystyrene (HIP); polyethylene terephthalate (PET) modified with cyclohexanedimethanol (CHDM); polycarbonate (PC); acrylonitrile/styrene/acrylate polymer (ASA); polyvinylchloride (PVC); copolymer alloy (CPA); thermoplastic olefin copolymers (TPO); acrylonitrile butadiene styrene (ABS); ethylene propylene diene terpolymer (EPDM); thermoplastic elastomers (TPE); polyethylene (PE); polypropylene (PP); polyurethane foam (PU) and mixtures of said semi-weatherable plastic materials.

77. A method as claimed in claims 44, 45, or 46 in which said layers are bonded with heat and subsequently annealed to provide enhanced resistance to heat distortion for dimensional stability of said roofing product.

78. A method as claimed in claim 45 or 46 further comprising the steps of:
annealing said roofing product.

79. A method as claimed in claims 45 or 46 further comprising the step of forming said roofing product to have a raised central portion and a flat lip whereby a chamber is defined.

80. A method as claimed in claim 79 in which said chamber traps a pocket of air, thus increasing insulation of said roofing product.

81. A method as claimed in claim 79 further comprising the step of filling said chamber with a material selected from the group consisting of polyurethane foam, intumescent fire retardant/fire resistant, and fire retardant/fire resistant foam.

82. A method as claimed in claim 81 further comprising a fire-resistant/fire retardant mineral core layer above said fire retardant/fire resistant foam layer.

83. A method as claimed in claim 82 in which said fire-resistant/fire retardant mineral core layer comprises materials selected from the group consisting of fiber glass, glass wool, gypsum, wood-chips, saw-dust, silica, glass fillers and their mixtures.

84. A method as claimed in claim 81 further comprising the steps of bonding an encapsulating layer below the foam in said chamber; said encapsulating layer selected from the group consisting of semi-weatherable plastic and intumescent foam.

85. A method as claimed in claim 44 or 45 further comprising the step of thermoforming said roofing product to resemble a popular roofing product.

86. A roofing product in combination with a roof as claimed in claims 1, 2 or 3 in which said additives are of a size selected from the group consisting of nanoparticles, micron sized particles and mixtures of nanoparticles and micron sized particles.

87. A method as claimed in claims 43, 44 or 45 in which said additives are of a size selected from the group consisting of nanoparticles, micron sized particles and mixtures of nanoparticles and micron sized particles.

88. A roofing product in combination with a roof as claimed in claims 2 or 3 further comprising an additional layer of UV resistant colorant on top of said roofing product.

89. A method as claimed in claims 44 or 45 further comprising the step of applying an additional layer of UV resistant colorant to the top of said roofing product.

90. A method of increasing the heat deflection temperature of formulated semi-weatherable plastic; said method comprising the steps of:
obtaining formulated semi-weatherable plastic;
obtaining an alloying material selected from the group consisting of ASA, ABS, Acrylic, PMMA or other and compatible plastics;
extruding said formulated semi-weatherable plastic at a temperature between 325° F. and 425° F. to form thermally processed, formulated semi-weatherable plastic; whereby said formulated semi-weatherable plastic becomes annealed;
extruding said alloying material at a temperature between 375° F. and 450° F. to form thermally processed, alloying material; whereby said formulated alloying material becomes annealed;
mixing up to 50% of said thermally processed, formulated semi-weatherable plastic with the remaining balance of said formulated semi-weatherable plastic to form a penultimate mixture; and mixing up to 25% of said thermally processed, alloying material with the remaining balance of said penultimate mixture.
